(19) United States
(12) Patent Application Publication
(10) Pub. No.: US 2022/0267526 A1
(43) Pub. Date: Aug. 25, 2022

(54) MALEIMIDE RESIN FILM AND COMPOSITION FOR MALEIMIDE RESIN FILM

(71) Applicant: Shin-Etsu Chemical Co., Ltd., Tokyo (JP)

(72) Inventors: Hiroyuki IGUCHI, Annaka-shi (JP); Yoshihiro TSUTSUMI, Annaka-shi (JP); Tsutomu KASHIWAGI, Annaka-shi (JP)

(73) Assignee: Shin-Etsu Chemical Co., Ltd., Tokyo (JP)

(21) Appl. No.: 17/734,876

(22) Filed: May 2, 2022

Related U.S. Application Data
(63) Continuation of application No. 16/990,310, filed on Aug. 11, 2020.

(30) Foreign Application Priority Data
Sep. 3, 2019 (JP) 2019-160513

(51) Int. Cl. C08G 73/10; C08K 3/36; C08K 3/105; C08K 3/11; C08K 3/22; C08K 3/08; C08K 3/38; C08G 73/12; C08L 79/08

(52) U.S. Cl. CPC C08G 73/10; C08K 2003/2268; C08K 3/105; C08K 3/11; C08K 3/22; C08K 3/08; C08K 3/38; C08G 73/12; C08L 79/085; C08G 73/126; C08K 2003/0806; C08K 2201/001; C08K 2003/385; C08K 2003/2241; C08K 2003/2227; C08K 2003/2289; C08K 2003/2206; C08K 3/36

(57) ABSTRACT

Provided is a maleimide resin film highly filled with inorganic particles and having a superior adhesion force. The maleimide resin film contains:
(a) a maleimide represented by the following formula (1):

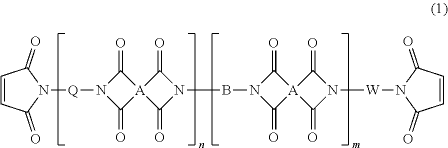

wherein A independently represents a tetravalent organic group having a cyclic structure(s); B independently represents an alkylene group that has not less than 6 carbon atoms and at least one aliphatic ring having not less than 5 carbon atoms, and may contain a hetero atom; Q independently represents an arylene group that has not less than 6 carbon atoms, and may contain a hetero atom; W represents a group represented by B or Q; n represents a number of 0 to 100, m represents a number of 0 to 100, provided that at least one of n or m is a positive number;
(b) a (meth)acrylate;
(c) inorganic particles; and
(d) a curing catalyst.

### CROSS-REFERENCE TO RELATED APPLICATIONS

This application is a Continuation of co-pending application Ser. No. 16/990,310, filed on Aug. 11, 2020, which claims priority under 35 U.S.C. § 119(a) to Application No. 2019-160513, filed in Japan on Sep. 3, 2019, all of which are hereby expressly incorporated by reference into the present application.

### BACKGROUND OF THE INVENTION

### Field of the Invention

The present invention relates to a maleimide resin film and a composition for a maleimide resin film.

### Background Art

In recent years, as electronic devices have become more sophisticated, smaller, lighter and so on, semiconductor packages are now produced via high-density packaging, and a higher degree of integration and a higher speed are now required for LSI, for example. In this regard, since the amount of heat generated from various electronic parts is larger than before, it is now critical to develop a heat-countermeasure to effectively dissipate such heat from the electronic parts. As such heat-countermeasure, thermally conductive molded products comprised of heat dissipation materials such as metals, ceramics and polymeric compositions are used in heat dissipation members such as a printed-wiring board, a semiconductor package, a housing, a heat pipe, a heatsink and a thermal diffusion plate. Particularly, the number of the electronic parts installed in a vehicle is larger than before as more vehicles are now electric vehicles, and employ automated driving where safety and risk management such as collision prevention is required; the electronic parts installed in such vehicle are usually light, thin, short and small. That is, it is essential to have a countermeasure against the heat generated from those electronic parts.

Conventionally, a high thermal conductive resin or a molded product thereof is produced by highly filling a curable resin such as a silicone resin and an epoxy resin with high thermal conductive particles. However, the molded product will become hard and brittle as a result of highly filling the silicone resin or epoxy resin with the high thermal conductive particles (JP-A-2000-204259 and JP-A-2018-087299).

As a countermeasure, there is known a method for improving thermal conductivity by orienting scale-, fiber- or plate-shaped thermal conductive particles toward a thickness direction (WO2018/030430 and WO2017/179318). However, it is difficult to orient the thermal conductive particles in the composition i.e. the method has a downside of being inferior in productivity.

There is also known a method for improving the thermal conductivity of a composition by improving the thermal conductivity of a resin itself (WO2017/111115). However, this method is only applicable when using a resin such as a liquid crystal polymer resin having a mesogenic backbone i.e. it is difficult to impart a flexibility to a cured molded product.

Maleimide resin is known to have a flexibility and heat resistance due to a main chain backbone thereof, and is used in, for example, flexible printed-wiring boards (WO2016/114287). Further, there is known a method for reducing a linear expansion coefficient by mixing a maleimide resin with an epoxy resin, a phenolic resin and the like, and then highly filling the mixture with inorganic particles (JP-A-2018-083893). However, with this method, an adhesion force to an electronic part(s) was insufficient.

### SUMMARY OF THE INVENTION

Thus, it is an object of the present invention to provide a maleimide resin film highly filled with inorganic particles, and having a sufficient adhesion force.

The inventors of the present invention diligently conducted a series of studies to achieve the abovementioned objective, and completed the invention as follows. That is, the inventors found that the following maleimide resin film could solve the aforementioned problem.

Specifically, the present invention is to provide the following maleimide resin film.

[1]

A maleimide resin film comprising:

(a) a maleimide represented by the following formula (1):

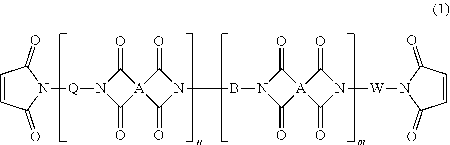

wherein A independently represents a tetravalent organic group having a cyclic structure(s); B independently represents an alkylene group that has not less than 6 carbon atoms and at least one aliphatic ring having not less than 5 carbon atoms, and may contain a hetero atom; Q independently represents an arylene group that has not less than 6 carbon atoms, and may contain a hetero atom; W represents a group represented by B or Q, n represents a number of 0 to 100, m represents a number of 0 to 100, provided that at least one of n or m is a positive number:

(b) a (meth)acrylate having not less than 10 carbon atoms:

(c) inorganic particles in an amount of 70 to 90% by volume with respect to the whole resin film; and

(d) a curing catalyst.

[2]

The maleimide resin film according to [1], wherein the organic group represented by A in the formula (1) is any one of the tetravalent organic groups represented by the following structural formulae

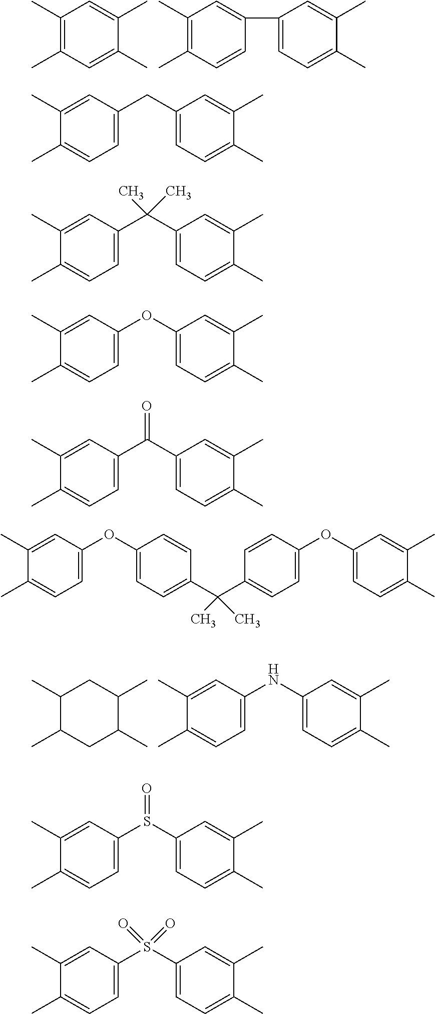

wherein bonds in the above structural formulae that are yet unbonded to substituent groups are to be bonded to carbonyl carbons forming cyclic imide structures in the formula (1).
[3]

The maleimide resin film according to [1] or [2], wherein the component (b) which is the(meth)acrylate having not less than 10 carbon atoms has at least one aliphatic ring having not less than 5 carbon atoms.

[4]

The maleimide resin film according to any one of [1] to [3], wherein the inorganic particles as the component (c) are at least one selected from the group consisting of electrically conductive particles, thermally conductive particles, a phosphor, magnetic particles, white particles, hollow particles and electromagnetic wave-absorbing particles.

[5]

The maleimide resin film according to any one of [1] to [4], wherein the inorganic particles as the component (c) are at least one kind of electrically conductive particles selected from elemental metal particles that are gold particles, silver particles, copper particles, palladium particles, aluminum particles, nickel particles, iron particles, titanium particles, manganese particles, zinc particles, tungsten particles, platinum particles, lead particles and tin particles; and alloy particles that are solder particles, steel particles and stainless steel particles.

[6]

The maleimide resin film according to any one of [1] to [4], wherein the inorganic particles as the component (c) are at least one kind of thermally conductive particles selected from the group consisting of boron nitride particles, aluminum nitride particles, silicon nitride particles, beryllium oxide particles, magnesium oxide particles, zinc oxide particles, aluminum oxide particles, silicon carbide particles, diamond particles and graphene particles.

[7]

The maleimide resin film according to any one of [1] to [4], wherein the inorganic particles as the component (c) are at least one kind of magnetic particles selected from the group consisting of iron particles, cobalt particles, nickel particles, stainless steel particles, Fe—Cr—Al—Si alloy particles, Fe—Si—Al alloy particles, Fe—Ni alloy particles, Fe—Cu—Si alloy particles, Fe—Si alloy particles, Fe—Si—B(—Cu—Nb) alloy particles, Fe—Si—Cr—Ni alloy particles, Fe—Si—Cr alloy particles, Fe—Si—Al—Ni—Cr alloy particles, Fe₂O₃ particles, Fe₃O₄ particles. Mn—Zn-based ferrite particles, Ni—Zn-based ferrite particles, Mg—Mn-based ferrite particles, Zr—Mn-based ferrite particles, Ti—Mn-based ferrite particles, Mn—Zn—Cu-based ferrite particles, barium ferrite particles and strontium ferrite particles.

[8]

The maleimide resin film according to any one of [1] to [4], wherein the inorganic particles as the component (c) are at least one kind of white particles selected from the group consisting of titanium dioxide particles, yttrium oxide particles, zinc sulfate particles, zinc oxide particles and magnesium oxide particles.

[9]

The maleimide resin film according to any one of [1] to [4], wherein the inorganic particles as the component (c) are at least one kind of hollow particles selected from the group consisting of silica balloons, carbon balloons, alumina balloons, aluminosilicate balloons and zirconia balloons.

[10]

The maleimide resin film according to any one of [1] to [4], wherein the inorganic particles as the component (c) are at least one kind of electromagnetic wave-absorbing particles selected from the group consisting of carbon black particles, acetylene black particles, ketjen black particles, carbon nanotube particles, graphene particles, fullerene particles, carbonyl iron particles, electrolytic iron particles. Fe—Cr-based alloy particles, Fe—Al-based alloy particles, Fe—Co-based alloy particles, Fe—Cr—Al-based alloy particles. Fe—Si—Ni-based alloy particles, Mg—Zn-based ferrite particles, Ba₂Co₂Fe₁₂O₂₂ particles, Ba₂Ni₂Fe₁₂O₂₂ particles, Ba₂Zn₂Fe₁₂O₂₂ particles, Ba₂Mn₂Fe₁₂O₂₂ particles, Ba₂Mg₃Fe₁₂O₂₂ particles, Ba₂Cu₂Fe₁₂O₂₂ particles, Ba₃Co₂Fe₂₄O₄₁ particles, BaFe₁₂O₁₉ particles, SrFe₁₂O₁₉ particles, BaFe₁₂O₁₉ particles and SrFe₁₂O₁₁ particles.

[11]

A maleimide resin composition composing the maleimide resin film according to any one of [1] to [10], further comprising (e) an inorganic solvent, the maleimide resin composition having a thixotropic ratio of 1.0 to 3.0 at 25° C.

The maleimide resin film of the present invention is superior in adhesion force even though it is highly filled with inorganic particles. Thus, the maleimide resin film is useful for many purposes, as it serves as a resin film that may have various functions depending on the properties of the inorganic particles used therein. Further, when the inorganic particles used do not possess electric conductivity, the film shall be useful as an adhesive resin film having a low dielectric property.

### DETAILED DESCRIPTION OF THE INVENTION

The maleimide resin film of the present invention is described in detail hereunder.

### (a) Maleimide

A component (a) of the present invention is a main component of the maleimide resin film of the present invention, and is a maleimide represented by the following formula (1).

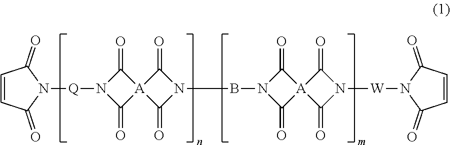

In the formula (1), A independently represents a tetravalent organic group having a cyclic structure(s); B independently represents an alkylene group that has not less than 6 carbon atoms and at least one aliphatic ring having not less than 5 carbon atoms, and may contain a hetero atom; Q independently represents an arylene group that has not less than 6 carbon atoms, and may contain a hetero atom; W represents a group represented by B or Q; n represents a number of 0 to 100, m represents a number of 0 to 100, provided that at least one of n or m is a positive number.

Here, the organic group expressed by A in the formula (1) independently represents a tetravalent organic group having a cyclic structure, and is preferably any one of the tetravalent organic groups represented by the following structural formulae:

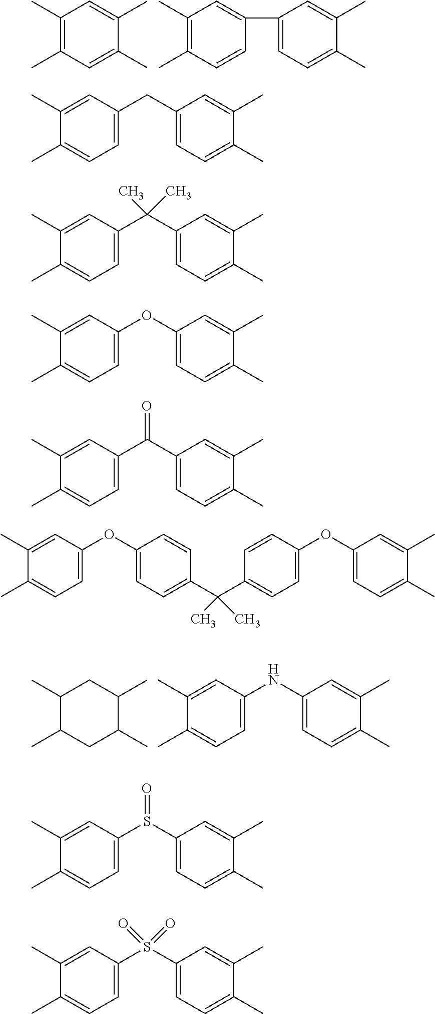

wherein bonds in the above structural formulae that are yet unbonded to substituent groups are to be bonded to carbonyl carbons forming cyclic imide structures in the formula (1).

Further, B in the formula (1) independently represents an alkylene group that has not less than 6, preferably not less than 8 carbon atoms, and may contain a hetero atom, and an alkylene group that has at least one aliphatic ring having not less than 5, preferably 6 to 12 carbon atoms. It is more preferred that B in the formula (1) be any one of the aliphatic ring-containing alkylene groups represented by the follow % ing structural formulae. By having an aliphatic ring(s) in a molecule, the composition can then be highly filled with inorganic particles (c).

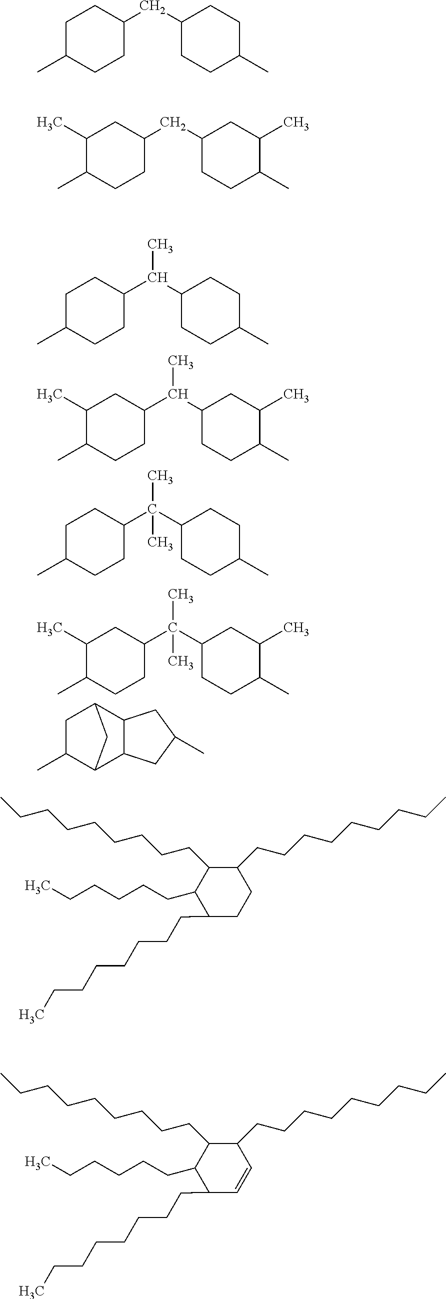

Bonds in the above structural formulae that are yet unbonded to substituent groups are to be bonded to nitrogen atoms forming cyclic imide structures in the formula (1).

Q independently represents an arylene group that has not less than 6, preferably not less than 8 carbon atoms, and may contain a hetero atom. It is more preferred that Q in the formula (1) be any one of the aromatic ring-containing arylene groups represented by the following structural formulae:

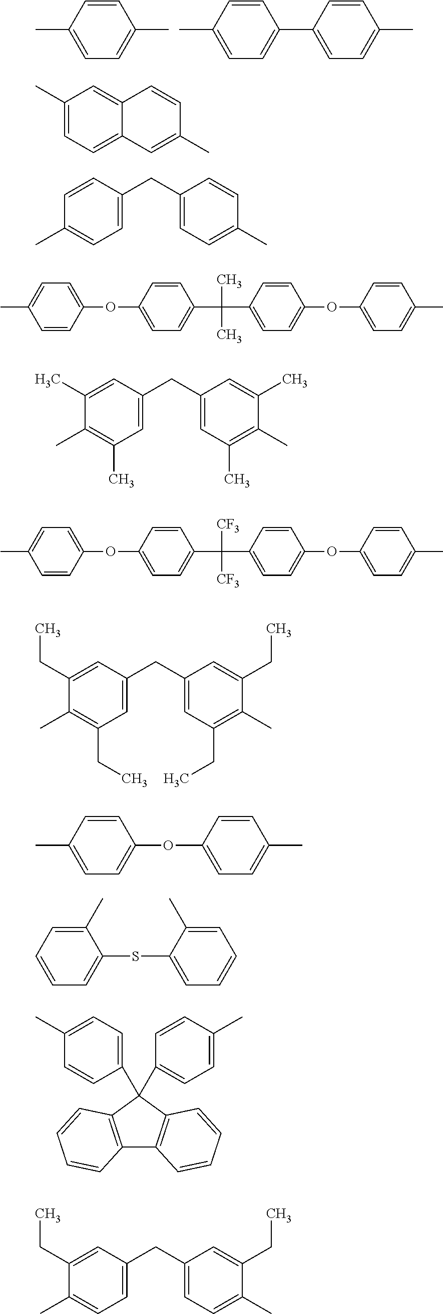

Bonds in the above structural formulae that are yet unbonded to substituent groups are to be bonded to nitrogen atoms forming cyclic imide structures in the formula (1).

In the formula (1), n represents a number of 0 to 100, preferably a number of 0 to 70. In the formula (1), m represents a number of 0 to 100, preferably a number of 0 to 70. Further, at least one of n or m represents a positive number.

While there are no particular restrictions on the molecular weight of the above maleimide, it is preferred that the molecular weight thereof be 2,000 to 50,000, more preferably 2,200 to 30,000, even more preferably 2,500 to 20,000. It is preferable when the molecular weight of the component (a) is within these ranges, because the composition for producing the maleimide resin film will not exhibit an excessively high viscosity, and a cured product of such resin film will have a high strength. Here, the term “molecular weight” referred to in this specification is a weight-average molecular weight measured by GPC under the following conditions, using polystyrene as a reference substance.

Measurement condition
Developing solvent: tetrahydrofuran
Flow rate: 0.35 mL/min

### Detector: RI

Column: TSK-GEL Super HZ type (by TOSOH CORPORATION)
Super HZ4000 (4.6 mm I.D.×15 cm×1)
Super HZ3000 (4.6 mm I.D.×15 cm×1)
Super HZ2000 (4.6 mm I.D.×15 cm×1)
Column temperature: 40° C.
Sample injection volume: 5 μL (THF solution having concentration of 0.1% by weight)

While there are no particular restrictions on the amount of the above maleimide, the maleimide is added in an amount of 50 to 99 parts by mass, preferably 60 to 95 parts by mass, more preferably 70 to 90 parts by mass, per 100 parts by mass of the resin content in the resin film. When the amount of the maleimide is within these ranges, the composition can then be highly filled with inorganic particles as a component (c), and the resin film will have a sufficient adhesion force.

As the maleimide, it may be synthesized by a common procedure from diamine and an acid anhydride, or a commercially available product may be used. Examples of such commercially available product include BMI-1400, BMI-1500, BMI-2500, BMI-2560, BMI-3000, BMI-5000, BMI-6000 and BMI-6100 (all by Designer Molecules Inc.). Further, one kind of maleimide may be used alone, or two or more kinds thereof may be used in combination.

It is preferred that the component (a) be added in an amount of 40 to 95 parts by mass. more preferably 50 to 90 parts by mass, even more preferably 70 to 90 parts by mass, per 100 parts by mass of the resin content in the resin film. Here, the term “resin content” refers to a sum total of the components (a), (b) and (d).

(B) (Meth)Acrylate Having not Less than 10 Carbon Atoms

A component (b) is a compound having a favorable compatibility with inorganic particles as is the case with the maleimide as the component (a), and capable of improving an adhesion force of the resin film.

The component (b) is a (meth)acrylate having not less than 10, preferably not less than 12, more preferably 14 to 40 carbon atoms. When the number of the carbon atoms in the (meth)acrylate is smaller than 10, it will be difficult to achieve, for example, an effect of improving the adhesion force of the resin film, and a flexibility of an uncured resin film will not be able to be improved.

While there are no particular restrictions on the number of the (meth)acrylic groups in each molecule of the component (b), such number is 1 to 3, preferably 1 or 2. It is preferable when the number of the (meth)acrylic groups in each molecule of the component (b) is 1 to 3, because the resin film will only undergo a small degree of contraction at the time of curing, and the adhesion force will not deteriorate.

Specific examples of the component (b) include, but are not limited to the compounds represented by the following structural formulae:

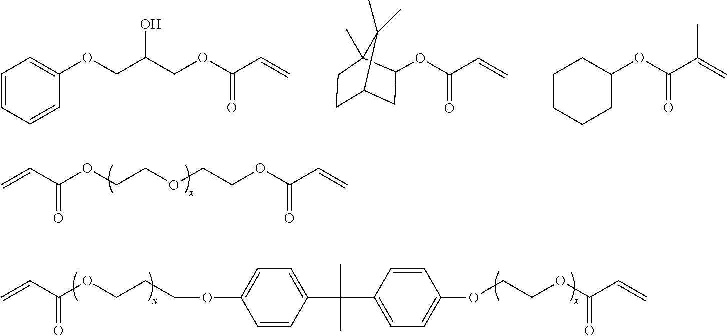

In the above formulae, x is each within a range of 1 to 30.

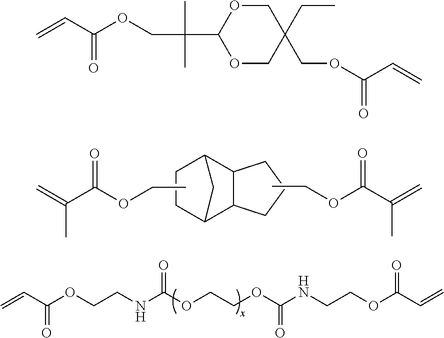

In the above formulae, x is within a range of 1 to 30.

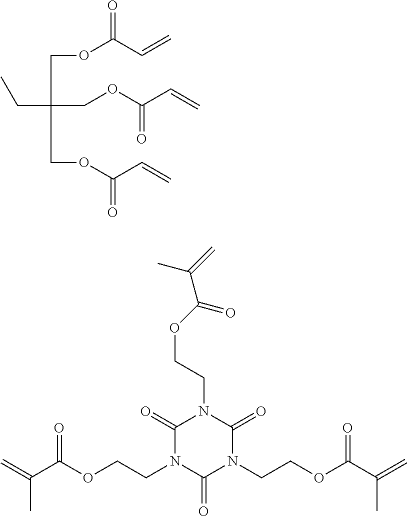 [SMILES: C=CC(=O)OCC(CC)(COC(=O)C=C)COC(=O)C=C ; C=C(C)C(=O)OCCn1c(=O)n(CCOC(=O)C(=C)C)c(=O)n(CCOC(=O)C(=C)C)c1=O]

Even in the above examples, the component (b) is preferably that having, in each molecule, at least one aliphatic ring having not less than 5, preferably 6 to 12 carbon atoms.

While there are no particular restrictions on the amount of the component (b), the component (b) is added in an amount of 1 to 50 parts by mass, preferably 3 to 30 parts by mass, more preferably 5 to 20 parts by mass, per 100 parts by mass of the resin content in the resin film. When the amount of the component (b) is within these ranges, the composition can then be highly filled with the inorganic particles as the component (c), and the resin film will have a sufficient adhesion force.

### (c) Inorganic Particles

The component (c) used in the present invention is a component that determines the property of the maleimide resin film of the invention. Examples of the component (c) include electrically conductive particles, thermally conductive particles, a phosphor, magnetic particles, white particles, hollow particles and electromagnetic wave-absorbing particles.

There are no particular restrictions on the electrically conductive particles, and the electrically conductive particles may be appropriately selected depending on intended use. Examples of such electrically conductive particles include metal particles and metal-coated particles, among which metal particles are preferred as they have small electrical resistances and can also be sintered at a high temperature.

Examples of the metal particles include elemental metal particles such as gold particles, silver particles, copper particles, palladium particles, aluminum particles, nickel particles, iron particles, titanium particles, manganese particles, zinc particles, tungsten particles, platinum particles, lead particles and tin particles; or alloy particles such as solder particles, steel particles and stainless steel particles. Preferred are silver particles, copper particles, aluminum particles, iron particles, zinc particles and solder particles, more preferred are silver particles, copper particles, aluminum particles and solder particles. Any one kind of these particles may be used alone, or two or more kinds thereof may be used in combination.

Examples of the metal-coated particles include resin particles such as acrylic resin particles and epoxy resin particles with surfaces thereof being coated with a metal; and inorganic particles such as glass particles and ceramic particles with surfaces thereof being coated with metal. There are no particular restrictions on a method for coating the surfaces of the particles with a metal; there may be employed, for example, a non-electrolytic plating method and a sputtering method.

Examples of a metal used to coat the surfaces of the particles include gold, silver, copper, iron, nickel and aluminum.

The electrically conductive particles are simply required to possess electric conductivity when electrically connected to a circuit electrode(s). For example, even in the case of particles with surfaces thereof being coated with an insulation coating film, the particles will be considered as electrically conductive particles so long as they are capable of exposing the metal particles therein as a result of undergoing deformation upon electrical connection.

There are no particular restrictions on the shape of the electrically conductive particles. The electrically conductive particles may have, for example, a spherical shape, a scale-like shape, a flake-like shape, a needle-like shape, a rod-like shape and an oval shape. Among these shapes, preferred are a spherical shape, a scale-like shape, an oval shape and a rod-like shape; more preferred are a spherical shape, a scale-like shape and an oval shape.

While there are no particular restrictions on the particle size of the electrically conductive particles, it is preferred that the particle size thereof be 0.05 to 50 μm, more preferably 0.1 to 40 μm, even more preferably 0.5 to 30 μm, in terms of a median diameter measured by a laser diffraction-type particle size distribution measuring device. It is preferable when the particle size of the electrically conductive particles is within these ranges, because the particles can then be easily dispersed in the resin film in a uniform manner, and will not settle, separate and/or be unevenly distributed with time. Further, it is preferred that the particle size be 50% or less of the film thickness. It is preferable when the particle size is 50% or less of the film thickness, because the electrically conductive particles can then be easily dispersed in the resin film in a uniform manner, and an even flatter film can also be easily obtained.

There are no particular restrictions on the thermally conductive particles. However, in terms of thermal conductivity, it is preferred that the thermally conductive particles be at least one of boron nitride particles, aluminum nitride particles, silicon nitride particles, beryllium oxide particles, magnesium oxide particles, zinc oxide particles, aluminum oxide particles, silicon carbide particles, diamond particles and graphene particles. Among these thermally conductive particles, preferred are boron nitride particles, aluminum nitride particles, aluminum oxide particles, magnesium oxide particles and graphene particles. Any one kind of these thermally conductive particles may be used alone, or two or more kinds thereof may be used in combination.

There are no particular restrictions on the shape of the thermally conductive particles. The thermally conductive particles may have, for example, a spherical shape, a scale-like shape, a flake-like shape, a needle-like shape, a rod-like shape and an oval shape. Among these shapes. preferred are a spherical shape, a scale-like shape, an oval shape and a rod-like shape; more preferred are a spherical shape, a scale-like shape and an oval shape.

While there are no particular restrictions on the particle size of the thermally conductive particles, it is preferred that the particle size thereof be 0.05 to 50 μm, more preferably 0.1 to 40 μm, even more preferably 0.5 to 30 μm, in terms of a median diameter measured by a laser diffraction-type particle size distribution measuring device. It is preferable when the particle size of the thermally conductive particles is within these ranges, because the particles can then be easily dispersed in the resin film in a uniform manner, and will not settle, separate and/or be unevenly distributed with time. Further, it is preferred that the particle size be 50% or less of the film thickness. It is preferable when the particle size is 50% or less of the film thickness, because the thermally conductive particles can then be easily dispersed in the resin film in a uniform manner, and an even flatter film can also be easily obtained.

As the abovementioned phosphor, there may be used, for example, those capable of absorbing a light(s) from a semiconductor light-emitting diode having a nitride-based semiconductor as its light-emitting layer, and then converting the wavelength of the light to a different wavelength. Examples of such phosphor include nitride-based phosphors and oxynitride-based phosphors which are mainly activated by lanthanoid elements such as Eu and Ce; alkaline-earth metal halogen apatite phosphors, alkaline-earth metal borate halogen phosphors, alkaline-earth metal aluminate phosphors, alkaline-earth metal silicate phosphors, alkaline-earth metal sulfide phosphors, rare-earth sulfide phosphors, alkaline-earth metal thiogallate phosphors, alkaline-earth metal silicon nitride phosphors and germanate phosphors which are mainly activated by lanthanoid elements such as Eu, and transition metal elements such as Mn; rare-earth aluminate phosphors and rare-earth silicate phosphors which are mainly activated by lanthanoid elements such as Ce; and Ca—Al—Si—O—N-based oxynitride glass phosphors which are mainly activated by lanthanoid elements such as Eu. Any one of these phosphors may be used alone, or two or more of them may be used in combination. Specific examples of the phosphor(s) include, but are not limited to the following substances.

Examples of a nitride-based phosphor mainly activated by lanthanoid elements such as Eu and Ce include M₂Si₅N₈:Eu, MSi₇N₁₀:Eu, M_{1.7}Si₅O_{0.2}N₈:Eu and M_{0.9}Si₇O_{0.1}N₁₀:Eu (M represents at least one selected from Sr, Ca. Ba, Mg and Zn).

Examples of an oxynitride-based phosphor mainly activated by lanthanoid elements such as Eu and Ce include MSi₂O₂N₂:Eu (M represents at least one selected from Sr, Ca, Ba, Mg and Zn).

Examples of an alkaline-earth metal halogen apatite phosphor mainly activated by lanthanoid elements such as Eu, and transition metal elements such as Mn include M₅(PO₄)₃X:Z (M represents at least one selected from Sr, Ca, Ba and Mg; X represents at least one selected from F, Cl. Br and I; Z represents at least one selected from Eu and Mn).

Examples of an alkaline-earth metal borate halogen phosphor mainly activated by lanthanoid elements such as Eu. and transition metal elements such as Mn include M₂B₅O₉X:Z (M represents at least one selected from Sr, Ca, Ba and Mg; X represents at least one selected from F, Cl. Br and I; Z represents at least one selected from Eu and Mn).

Examples of an alkaline-earth metal aluminate phosphor mainly activated by lanthanoid elements such as Eu, and transition metal elements such as Mn include SrAl₂O₄:Z, Sr₄Al₁₄O₂₅:Z, CaAl₂O₄:Z. BaMg₂Al₁₆O₂₇:Z, BaMg₂Al₁₆O₁₂:Z and BaMgAl₁₀O₁₇:Z (Z represents at least one selected from Eu and Mn).

Examples of an alkaline-earth metal silicate phosphor mainly activated by lanthanoid elements such as Eu, and transition metal elements such as Mn include (BaMg)Si₂O₅:Eu and (BaSrCa)₂SiO₄:Eu.

Examples of an alkaline-earth metal sulfide phosphor mainly activated by lanthanoid elements such as Eu, and transition metal elements such as Mn include (Ba, Sr, Ca) (Al, Ga)₂S₄:Eu.

Examples of a rare-earth sulfide phosphor mainly activated by lanthanoid elements such as Eu, and transition metal elements such as Mn include La₂O₂S:Eu. Y₂O₂S:Eu and Gd₂O₂S:Eu.

Examples of an alkaline-earth metal thiogallate phosphor mainly activated by lanthanoid elements such as Eu, and transition metal elements such as Mn include MGa₂S₄:Eu (M represents at least one selected from Sr, Ca. Ba, Mg and Zn).

Examples of an alkaline-earth metal silicon nitride phosphor mainly activated by lanthanoid elements such as Eu, and transition metal elements such as Mn include (Ca. Sr, Ba)AlSiN₃:Eu, (Ca, Sr, Ba)₂Si₅Ns:Eu and SrAlSi₄N₇:Eu.

Examples of a germanate phosphor mainly activated by lanthanoid elements such as Eu. and transition metal elements such as Mn include Zn₂GeO₄:Mn.

Examples of a rare-earth aluminate phosphor mainly activated by lanthanoid elements such as Ce include YAG-based phosphors such as Y₃Al₅O₁₂:Ce, (Y_{0.8}Gd_{0.2})₃Al₅O₁₂:Ce, Y₃(Al_{0.8}Ga_{0.2})₅O₁₂:Ce and (Y, Gd)₃(Al, Ga)₅O₁₂. Further, there may also be used, for example. Tb₃Al₅O₁₂:Ce and Lu₃Al₅O₁₂:Ce which are obtained by substituting part of or all the Ys in the above examples with Tb, Lu or the like.

Examples of a rare-earth silicate phosphor mainly activated by lanthanoid elements such as Ce include Y₂SiO₅:Ce and Tb.

A Ca—Al—Si—O—N-based oxynitride glass phosphor refers to a phosphor whose base material is an oxynitride glass containing, by mol %, 20 to 50 mol % of CaCO₃ in terms of CaO, 0 to 30 mol % of Al₂O₃, 25 to 60 mol % of SiO, 5 to 50 mol % of AlN and 0.1 to 20 mol % of a rare-earth oxide or a transition metal oxide, provided that a sum total of the five components is 100 mol %. Here, in the case of a phosphor whose base material is an oxynitride glass, it is preferred that a nitrogen content therein be not larger than 15% by mass. Further, it is preferred that other rare-earth element ions as sensitizers be contained in the state of a rare-earth oxide in addition to rare-earth oxide ions, and it is preferred that these rare-earth element ions be contained as coactivators in the phosphor by an amount of 0.1 to 10 mol %.

Examples of other phosphors include ZnS:Eu. Further, examples of silicate-based phosphors other than those listed above may include (BaSrMg)₃Si₂O₇:Pb, (BaMgSrZnCa)₃Si₂O₇:Pb, Zn₂SiO₄:Mn and BaSi₂O₅:Pb.

Furthermore, with regard to the above phosphor(s), instead of Eu or in addition to Eu, there may be used those containing at least one selected from Tb. Cu. Ag, Au, Cr, Nd, Dy, Co. Ni and Ti.

Furthermore, phosphors other than those described above may also be used in the present invention as inorganic particles, so long as they have similar functions and effects as those listed above.

There are no particular restrictions on the properties of the abovementioned phosphors. For example, a powdery phosphor may be used. Further, there are no particular restrictions on the shape of the phosphors. The phosphors may have, for example, a spherical shape, a scale-like shape, a flake-like shape, a needle-like shape, a rod-like shape and an oval shape. Among these shapes, preferred are a spherical shape, a scale-like shape and a flake-like shape; more preferred are a spherical shape and a flake-like shape.

While there are no particular restrictions on the particle size of the phosphors, it is preferred that the particle size thereof be 0.05 to 50 μm, more preferably 0.1 to 40 μm, even more preferably 0.5 to 30 μm, in terms of a median diameter measured by a laser diffraction-type particle size distribution measuring device. It is preferable when the particle size of the phosphors is within these ranges, because the phosphors can then be easily dispersed in the resin film in a uniform manner, and will not settle, separate and/or be unevenly distributed with time. Further, it is preferred that the particle size be 50% or less of the film thickness. It is preferable when the particle size is 50% or less of the film thickness, because the phosphors can then be easily dispersed in the resin film in a uniform manner, and an even flatter film can also be easily obtained.

There are no particular restrictions on the magnetic particles. However, preferable examples of the magnetic particles include ferromagnetic elemental metal particles such as iron particles, cobalt particles and nickel particles; magnetic metal alloy particles such as stainless steel particles, Fe—Cr—Al—Si alloy particles, Fe—Si—Al alloy particles, Fe—Ni alloy particles, Fe—Cu—Si alloy particles, Fe—Si alloy particles, Fe—Si—B(—Cu—Nb) alloy particles, Fe—Si—Cr—Ni alloy particles, Fe—Si—Cr alloy particles and Fe—Si—Al—Ni—Cr alloy particles; metal oxide particles such as hematite (Fe₂O₃) particles and magnetite (Fe₃O₄) particles; and ferrite particles such as Mn—Zn-based ferrite particles, Ni—Zn-based ferrite particles, Mg—Mn-based ferrite particles, Zr—Mn-based ferrite particles, Ti—Mn-based ferrite particles, Mn—Zn—Cu-based ferrite particles, barium ferrite particles and strontium ferrite particles.

By adding such magnetic particles, a magnetic property can then be imparted to the resin composition of the present invention, thus obtaining a resin composition that is highly permeable and low-loss in high-frequency bands.

There are no particular restrictions on the shape of the magnetic particles. The magnetic particles may have, for example, a spherical shape, a scale-like shape, a flake-like shape, a needle-like shape, a rod-like shape, an oval shape and a porous shape. Among these shapes, preferred are a spherical shape, a scale-like shape, an oval shape, a flake-like shape and a porous shape; more preferred are a spherical shape, a scale-like shape, a flake-like shape and a porous shape.

Porous magnetic particles can be produced by adding a pore adjuster such as calcium carbonate at the time of performing granulation, and then carrying out sintering. Further, complex pores can also be formed inside ferrite by adding a substance inhibiting the growth of the particles during the ferritization reaction. Examples of such substance include tantalum oxide and zirconium oxide.

While there are no particular restrictions on the particle size of the magnetic particles, it is preferred that the particle size thereof be 0.05 to 50 m, more preferably 0.1 to 40 μm, even more preferably 0.5 to 30 μm, in terms of a median diameter measured by a laser diffraction-type particle size distribution measuring device. It is preferable when the particle size of the magnetic particles is within these ranges, because the magnetic particles can then be easily dispersed in the resin film in a uniform manner, and will not settle with time. Further, it is preferred that the particle size be 50% or less of the film thickness, if the composition of the present invention is to be further processed into a film. It is preferable when the particle size is 50% or less of the film thickness, because the magnetic particles can then be easily dispersed in the resin film in a uniform manner, and an even flatter film can also be easily obtained.

The white particles are added to improve a whiteness required for a reflector or other purposes. Examples of a white pigment include titanium dioxide; yttrium oxide as a typical example of a rare-earth oxide; zinc sulfate; zinc oxide; and magnesium oxide. Any one of these pigments may be used alone, or two or more of them may be used in combination. Among these pigments, titanium dioxide is preferred in terms of further improving the whiteness. As the unit lattice of such titanium dioxide, there are those of rutile-type, anatase-type and brookite-type. While any of these types may be employed, rutile-type is preferred in terms of whiteness and photocatalytic property of titanium dioxide.

There are no particular restrictions on the shape of the w % bite particles. The white particles may have, for example, a spherical shape, a scale-like shape, a flake-like shape, a needle-like shape, a rod-like shape and an oval shape. Among these shapes, preferred are a spherical shape, an oval shape and a flake-like shape; more preferred is a spherical shape.

While there are no particular restrictions on the average particle size of the white particles, it is preferred that the average particle size thereof be 0.05 to 5 μm, more preferably not larger than 3 μm, even more preferably not larger than 1 μm, in terms of a median diameter measured by a laser diffraction-type particle size distribution measuring device. It is preferred that the particle size be 50% or less of a film thickness, if the composition of the present invention is to be further processed into a film. It is preferable when the particle size is 50% or less of the film thickness, because the white particles can then be easily dispersed in the resin film in a uniform manner, and an even flatter film can also be easily obtained.

It is preferred that the white particles be those that have already been surface-treated for the purpose of improving a wettability, compatibility, dispersibility and fluidity with respect to the resin; and it is even more preferred that the white particles be those that have been surface-treated with at least one, especially at least two treatment agents selected from silica, alumina, zirconia, polyol and an organic silicon compound.

Further, a titanium dioxide treated with an organic silicon compound is preferred in terms of improving an initial reflectivity and fluidity of the resin composition containing the white particles. Examples of the organic silicon compound include chlorosilane and silazane; a monomeric organic silicon compound such as a silane coupling agent having a reactive functional group(s) such as an epoxy group and an amino group; and an organopolysiloxane such as a silicone oil and a silicone resin. Here, there may also be used other treatment agents that are usually used to surface-treat titanium dioxide e.g. an organic acid such as stearic acid. The surface treatment may be carried out with a treatment agent other than those described above, or with multiple treatment agents.

There are no particular restrictions on the hollow particles. Examples of the hollow particles include silica balloons, carbon balloons, alumina balloons and aluminosilicate balloons.

There are no particular restrictions on the shape of the hollow particles. The hollow particles may have, for example, a spherical shape, an oval shape, a cylindrical shape and a prismatic shape. Among these shapes, preferred are a spherical shape, an oval shape and a prismatic shape; more preferred are a spherical shape and a prismatic shape.

While there are no particular restrictions on the average particle size of the hollow particles, it is preferred that the average particle size thereof be 0.01 to 5 μm, more preferably 0.03 to 3 μm, even more preferably 0.05 to 1 μm, in terms of a median diameter measured by a laser diffraction-type particle size distribution measuring device. Further, it is preferred that the particle size be 50% or less of a film thickness. It is preferable when the particle size is 50% or less of the film thickness, because the hollow particles can then be easily dispersed in the resin film in a uniform manner, and an even flatter film can also be easily obtained.

By adding the hollow particles, the cured product of the resin composition of the present invention will be able to readily have a lower specific gravity, and also become lighter.

There are no particular restrictions on the electromagnetic wave-absorbing particles. There may be used, for example, dielectric lossy electromagnetic wave-absorbing materials such as electrically conductive particles and carbon particles; and magnetic lossy electromagnetic wave-absorbing materials such as ferrite and a soft magnetic metal powder.

By adding the electromagnetic wave-absorbing particles, an electromagnetic wave-absorbing capability can then be imparted to the resin composition of the present invention, thereby easily obtaining a resin cured product having an electromagnetic wave-shielding property, such as a housing for an electronic device.

Examples of the dielectric lossy electromagnetic wave-absorbing materials include elemental metals such as gold, silver, copper, palladium, aluminum, nickel, iron, titanium, manganese, zinc, tungsten, platinum, lead and tin; and carbon particles such as carbon black particles, acetylene black particles, ketjen black particles, carbon nanotube particles, graphene particles and fullerene particles. Among these examples, preferred are carbon black particles, acetylene black particles, ketjen black particles, carbon nanotube particles, graphene particles and fullerene particles.

Examples of the magnetic lossy electromagnetic wave-absorbing materials include ferrite particles such as Mg—Zn-based ferrite particles, Ba₂Co₂Fe₁₂O₂₂ particles, Ba₂Ni₂Fe₁₂O₂₂ particles, Ba₂Zn₂Fe₁₂O₂₂ particles, Ba₂Mn₂Fe₁₂O₂₂ particles, Ba₂Mg₂Fe₁₂O₂₂ particles, Ba₂Cu₂Fe₁₂O₂₂ particles, Ba₃Co₂Fe₁₂O₂₂ particles, Ba₂Fe₁₂O₁₉ particles, SrFe₁₂O₁₉ particles, BaFe₁₂O₁₉ particles and SrFe₁₂O₁₉ particles; and soft magnetic alloy particles such as carbonyl iron particles, electrolytic iron particles. Fe—Cr-based alloy particles, Fe—Si-based alloy particles, Fe—Ni-based alloy particles, Fe—Al-based alloy particles. Fe—Co-based alloy particles, Fe—Al—Si-based alloy particles. Fe—Cr—Si-based alloy particles, Fe—Cr—Al-based alloy particles, Fe—Si—Ni-based alloy particles and Fe—Si—Cr—Ni-based alloy particles. Among these examples, it is preferred that there be used at least one selected from Mg—Zn-based ferrite particles, Ba₂Co₂Fe₁₂O₂₂ particles, Ba₂Ni₂Fe₁₂O₂₂ particles, Ba₂Zn₂Fe₁₂O₂₂ particles, Ba₂Mn₂Fe₁₂O₂₂ particles, Ba₂Mg₂Fe₁₂O₂₂ particles, Ba₂Cu₂Fe₁₂O₂₂ particles, Ba₃Co₂Fe₂₄O₄₁ particles, BaFe₁₂O₁₉ particles, SrFe₁₂O₁₉ particles, BaFe₁₂O₁₉ particles and SrFe₁₂O₁₉ particles.

Any one of these electromagnetic wave-absorbing particles may be used alone, or two or more of them may be used in combination.

There are no particular restrictions on the shape of the electromagnetic wave-absorbing particles. The electromagnetic wave-absorbing particles may have, for example, a spherical shape, a scale-like shape, a flake-like shape, a needle-like shape, a rod-like shape and an oval shape. Among these shapes, preferred are a spherical shape, a scale-like shape, an oval shape and a rod-like shape; more preferred are a spherical shape, a scale-like shape and an oval shape.

While there are no particular restrictions on the particle size of the electromagnetic wave-absorbing particles, it is preferred that the particle size thereof be 0.05 to 50 μm, more preferably 0.1 to 40 μm, even more preferably 0.5 to 30 μm, in terms of a median diameter measured by a laser diffraction-type particle size distribution measuring device. It is preferable when the particle size of the electromagnetic wave-absorbing particles is within these ranges, because the particles can then be easily dispersed in the resin film in a uniform manner, and will not settle, separate and/or be unevenly distributed with time. Further, it is preferred that the particle size be 50% or less of the film thickness. It is preferable when the particle size is 50% or less of the film thickness, because the electromagnetic wave-absorbing particles can then be easily dispersed in the resin film in a uniform manner, and the film can also be formed in a more flattened manner via coating.

In order for the resin film to exhibit the functions brought about by the inorganic particles, the percentage (%) of the inorganic particles by volume shall be considered as critical rather than the percentage (%) thereof by mass; it is preferred that the resin film be highly filled with the inorganic particles as much as possible. The amount of the inorganic particles in the present invention is characterized by being 70 to 90% by volume, preferably 72 to 88% by volume, more preferably 75 to 85% by volume, with respect to the whole resin film. When such amount of the inorganic particles is smaller than 70% by volume, the functions brought about by the inorganic particles cannot be fully exhibited; when the amount of the inorganic particles is larger than 90% by volume, not only the cured product of the resin film will become brittle, but a smaller adhesion force will be exhibited as well.

### (d) Curing Catalyst

A component (d) used in the present invention is a catalyst for curing the maleimide resin film. While there are no particular restrictions on a curing catalyst, there may be used, for example, a thermal radical polymerization initiator, a thermal cationic polymerization initiator, a thermal anionic polymerization initiator and a photopolymerization initiator.

Examples of a thermal radical polymerization initiator include organic peroxides such as methyl ethyl ketone peroxide, methyl cyclohexanone peroxide, methyl acetoacetate peroxide, acetylacetone peroxide, 1,1-bis(t-butylperoxy)3,3,5-trimethylcyclohexane, 1,1-bis(t-hexylperoxy)cyclohexane, 1,1-bis(t-hexylperoxy)3,3,5-trimethylcyclohexane, 1,1-bis(t-butylperoxy)cyclohexane, 2,2-bis(4,4-di-t-butylperoxycyclohexyl)propane, 1,1-bis(t-butylperoxy)cyclododecane, n-butyl-4,4-bis(t-butylperoxy)valerate, 2,2-bis(t-butylperoxy)butane, 1,1-bis(t-butylperoxy)-2-methylcyclohexane, t-butyl hydroperoxide, p-menthane hydroperoxide, 1,1,3,3-tetramethylbutyl hydroperoxide, t-hexyl hydroperoxide, dicumyl peroxide, 2,5-dimethyl-2,5-bis(t-butylperoxy)hexane, α,α′-bis(t-butylperoxy)diisopropylbenzene, t-butylcumyl peroxide, di-t-butyl peroxide, 2,5-dimethyl-2,5-bis(t-butylperoxy)hexyne-3, isobutyryl peroxide, 3,5,5-trimethyl hexanoyl peroxide, octanoyl peroxide, lauroyl peroxide, cinnamic acid peroxide, m-toluoyl peroxide, benzoyl peroxide, diisopropyl peroxy dicarbonate, bis(4-t-butylcyclohexyl)peroxydicarbonate, di-3-methoxybutyl peroxy dicarbonate, di-2-ethylhexyl peroxydicarbonate, di-sec-butyl peroxydicarbonate, di(3-methyl-3-methoxybutyl)peroxydicarbonate, di(4-t-butylcyclohexyl)peroxydicarbonate, α,α′-bis(neodecanoylperoxy)diisopropylbenzene, cumyl peroxyneodecanoate, 1,1,3,3-tetramethylbutyl peroxyneodecanoate, 1-cyclohexyl-1-methylethyl peroxyneodecanoate, t-hexyl peroxyneodecanoate, t-butyl peroxyneodecanoate, t-hexyl peroxypivalate, t-butyl peroxypivalate, 2,5-dimethyl-2,5-bis(2-ethylhexanoylperoxy)hexane, 1,1,3,3-tetramethylbutylperoxy-2-ethylhexanoate, 1-cyclohexyl-1-methylethylperoxy-2-ethylhexanoate, t-hexylperoxy-2-ethylhexanoate, t-butylperoxy-2-ethylhexanoate, t-butyl peroxyisobutyrate, t-butyl peroxymaleic acid, t-butyl peroxylaurate, t-butylperoxy-3,5,5-trimethylhexanoate, t-butylperoxyisopropyl monocarbonate, t-butylperoxy-2-ethylhexyl monocarbonate, 2,5-dimethyl-2,5-bis(benzoylperoxy)hexane, t-butyl peroxyacetate, t-hexyl peroxybenzoate, t-butylperoxy-m-toluoylbenzoate, t-butyl peroxybenzoate, bis (t-butylperoxy)isophthalate, t-butylperoxyallyl monocarbonate and 3,3′,4,4′-tetra(t-butylperoxycarbonyl)benzophenone; azo compounds such as 2,2′-azobis(N-butyl-2-methylpropionamide), 2,2′-azobis(N-cyclohexyl-2-methylpropionamide), 2,2′-azobis[N-(2-methylpropyl)-2-methylpropionamide], 2,2′-azobis[N-(2-methylethyl)-2-methylpropionamide], 2,2′-azobis(N-hexyl-2-methylpropionamide), 2,2′-azobis(N-propyl-2-methylpropionamide), 2,2′-azobis(N-ethyl-2-methylpropionamide), 2,2′-azobis[2-methyl-N-(2-hydroxyethyl)propionamide], 2,2′-azobis[N-(2-propenyl)-2-methylpropionamide], 2,2′-azobis{2-methyl-N-[1,1-bis(hydroxymethyl)-2-hydroxyethyl]propionamide}, 2,2′-azobis[N-(2-propenyl)-2-methylpropionamide] and dimethyl-1,1′-azobis(1-cyclohexanecarboxylate). Here, preferred are dicumyl peroxide, di-t-butyl peroxide, isobutyryl peroxide, 2,2′-azobis(N-butyl-2-methylpropionamide) and 2,2′-azobis[N-(2-methylethyl)-2-methylpropionamide]; more preferred are dicumyl peroxide and di-t-butyl peroxide and isobutyryl peroxide.

Examples of a thermal cationic polymerization initiator include aromatic iodonium salts such as (4-methylphenyl)[4-(2-methylpropyl)phenyl]iodonium cation, (4-methylphenyl)(4-isopropylphenyl)iodonium cation, (4-methylphenyl)(4-isobutyl)iodonium cation, bis(4-tert-butyl)iodonium cation, bis(4-dodecylphenyl)iodonium cation and (2,4,6-trimethylphenyl)[4-(1-methylacetic acid ethyl ether)phenyl] iodonium cation; and aromatic sulfonium salts such as diphenyl[4-(phenylthio)phenyl]sulfonium cation, triphenylsulfonium cation and alkyl triphenylsulfonium cation. Here, preferred are (4-methylphenyl)[4-(2-methylpropyl)phenyl]iodonium cation, (4-methylphenyl)(4-isopropylphenyl)iodonium cation, triphenylsulfonium cation and alkyl triphenylsulfonium cation; more preferred are (4-methylphenyl)[4-(2-methylpropyl)phenyl]iodonium cation and (4-methylphenyl)(4-isopropylphenyl)iodonium cation.

Examples of a thermal anionic polymerization initiator include imidazoles such as 2-methylimidazole, 2-ethylimidazole, 2-phenylimidazole, 2-ethyl-4-methylimidazole, 2-undecylimidazole and 1-cyanoethyl-2-ethyl-4-methylimidazole; amines such as triethylamine, triethylenediamine, 2-(dimethylamino methyl)phenol, 1,8-diaza-bicyclo[5,4,0]undecene-7, tris(dimethylamino methyl)phenol and benzyldimethylamine; and phosphines such as triphenylphosphine, tributylphosphine and trioctylphosphine. Preferred are 2-methylimidazole, 2-ethyl-4-methylimidazole, triethylamine, triethylenediamine, 1,8-diaza-bicyclo[5,4,0]undecene-7, triphenylphosphine and tributylphosphine. More preferred are 2-ethyl-4-methylimidazole, 1,8-diaza-bicyclo[5,4,0]undecene-7 and triphenylphosphine.

Although there are no particular restrictions on a photopolymerization initiator, examples thereof may include benzoyl compounds (or phenyl ketone compounds) such as benzophenone, particularly benzoyl compounds (or phenyl ketone compounds) having a hydroxy group on a carbon atom at the α-position of a carbonyl group, such as 1-hydroxycyclohexyl phenyl ketone, 2-hydroxy-2-methyl-1-phenylpropan-1-one and 1-(4-isopropylphenyl)-2-hydroxy-2-methylpropan-1-one; α-alkylaminophenone compounds such as 2-methyl-1-(4-methylthiophenyl)-2-morpholinopropan-1-one, 2-benzyl-2-dimethylamino-1-(4-morpholinophenyl)-1-butanone and 2-dimethylamino-2-(4-methyl-benzyl)-1-(4-morpholin-4-yl-phenyl)-butan-1-one; acylphosphine oxide compounds such as 2,4,6-trimethylbenzoyldiphenylphosphine oxide, bisacylmonoorganophosphine oxide and bis(2,6-dimethoxybenzoyl)-2,4,4-trimethylpentylphosphine oxide; benzoin ether compounds such as isobutylbenzoin ether; ketal compounds such as acetophenone diethyl ketal; thioxanthone-based compounds; and acetophenone-based compounds.

Particularly, since the radiation generated from a UV-LED is of single wavelength, it is effective to use photopolymerization initiators such as α-alkylaminophenone compounds and acylphosphine oxide compounds that have peaks in a range of 340 to 400 nm in absorption spectra, if employing a UV-LED as a light source.

Any one of these components (d) may be used alone, or two or more of them may be used in combination. While there are no particular restrictions on the amount of the component (d), the component (d) is contained in an amount of 0.01 to 10 parts by mass, preferably 0.05 to 8 parts by mass, more preferably 0.1 to 5 parts by mass, per 100 parts by mass of the resin film. When the amount of the component (d) is within these ranges, the maleimide resin film can be cured sufficiently.

In addition to the components (a) to (d), the maleimide resin film of the present invention may further contain, for example, an adhesion aid, an antioxidant and/or a flame retardant, if necessary. These components are described below.

### Adhesion Aid

There are no particular restrictions on an adhesin aid. Examples of an adhesion aid include silane coupling agents such as n-propyltrimethoxysilane, n-propyltriethoxysilane, n-octyltrimethoxysilane, n-octyltriethoxysilane, phenyltrimethoxysilane, phenyltriethoxysilane, methyltrimethoxysilane, methyltriethoxysilane, 2-[methoxy(polyethyleneoxy)propyl]-trimethoxysilane, methoxytri(ethyleneoxy)propyltrimethoxysilane, 3-aminopropyltrimethoxysilane, 3-mercaptopropyltrimethoxysilane, 3-(methacryloyloxy)propyltrimethoxysilane, 3-isocyanatopropyltriethoxysilane, 3-isocyanatopropyltrimethoxysilane and glycidoxypropyltrimethoxysilane; and isocyanurate compounds such as triallyl isocyanurate and triglycidyl isocyanurate.

While there are no particular restrictions on the amount of such adhesion aid, it is preferred that the adhesion aid be contained in an amount of 0.1 to 10 parts by mass, more preferably 0.5 to 8 parts by mass, even more preferably 1 to 5 parts by mass, per 100 parts by mass of the resin content in the resin film. When the amount of the adhesion aid is within these ranges, the adhesion force of the resin film can be further improved without changing the properties of the resin film.

### Antioxidant

There are no particular restrictions on an antioxidant. Examples of an antioxidant include phenolic antioxidants such as n-octadecyl-3-(3,5-di-t-butyl-4-hydroxyphenyl)propionate, n-octadecyl-3-(3,5-di-t-butyl-4-hydroxyphenyl)acetate, neododecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxyphenyl acetate, 2-(n-octadecylthio)ethyl-3,5-di-t-butyl-4-hydroxyphenyl acetate, 2-(n-octadecylthio)ethyl-3-(3,5-di-t-butyl-4-hydroxyphenyl)propionate, 2-(2-stearoyloxyethylthio)ethyl-7-(3-methyl-5-t-butyl-4-hydroxyphenyl)heptanoate and 2-hydroxyethyl-7-(3-methyl-5-t-butyl-4-hydroxyphenyl)propionate; sulfur-based antioxidants such as dilauryl-3,3′-thiodipropionate, dimyristyl-3,3′-thiodipropionate, distearyl-3,3′-thiodipropionate, ditridecyl-3,3′-thiodipropionate and pentaerythrityltetrakis(3-laurylthiopropionate); and phosphorus antioxidants such as tridecyl phosphite, triphenyl phosphite, tris(2,4-di-t-butylphenyl)phosphite, 2-ethylhexyldiphenyl phosphite, diphenyl tridecyl phosphite, 2,2-methylene bis(4,6-di-t-butylphenyl)octyl phosphite, distearyl pentaerythritol diphosphite, bis(2,6-di-t-butyl-4-methylphenyl)pentaerythritol diphosphite and 2-[12,4,8,10-tetrakis(1,1-dimethylethyl)dibenzo[d,f][1,3,2]dioxaphosphepin-6-yl]oxy-N,N-bis[2-[[2,4,8,10-tetrakis(1,1-dimethylethyl)dibenzo[d,f] [1,3,2]dioxaphosphepin-6-yl]oxy]-ethyl]ethanamine.

There are no particular restrictions on the amount of such antioxidant. It is preferred that the antioxidant be contained in an amount of 0.00001 to 5 parts by mass, more preferably 0.0001 to 4 parts by mass, even more preferably 0.001 to 3 parts by mass, per 100 parts by mass of the resin content in the resin film. When the amount of the antioxidant is within these ranges, the resin film can be prevented from being oxidized, without changing the mechanical properties of the resin film.

### Flame Retardant

There are not particular restrictions on a flame retardant; a phosphorus flame retardant, a metal hydrate and a halogen-based flame retardant may, for example, be used. Examples of a phosphorus flame retardant include red phosphorus; ammonium phosphates such as monoammonium phosphate, diammonium phosphate, triammonium phosphate and ammonium polyphosphate; inorganic nitrogen-containing phosphorus compounds such as phosphoric amide; phosphoric acid; phosphine oxide; triphenyl phosphate; tricresyl phosphate; trixylenyl phosphate; cresyldiphenyl phosphate; cresyl di-2,6-xylenyl phosphate; resorcinol bis(diphenylphosphate); 1,3-phenylene bis(di-2,6-xylenylphosphate); bisphenol A-bis(diphenylphosphate); 1,3-phenylene bis (diphenylphosphate); divinyl phenylphosphonate; diallyl phenylphosphonate; bis(1-butenyl) phenylphosphonate; diphenylphosphinic acid phenyl; diphenylphosphinic acid methyl; phosphazene compounds such as bis(2-allylphenoxy)phosphazene and dicresyl phosphazene; melamine phosphate; melamine pyrophosphate; melamine polyphosphate; melam polyphosphate; 9,10-dihydro-9-oxa-10-phosphaphenanthrene-10-oxide; and 10-(2,5-dihydroxyphenyl)-9,10-dihydro-9-oxa-10-phosphaphenanthrene-10-oxide. Examples of a metal hydrate include aluminum hydroxide hydrate and magnesium hydroxide hydrate. Examples of a halogen-based flame retardant include hexabromobenzene, pentabromotoluene, ethylenebis(pentabromophenyl), ethylenebistetrabromophthalimide, 1,2-dibromo-4-(1,2-dibromoethyl)cyclohexane, tetrabromocyclooctane, hexabromocyclododecane, bis(tribromophenoxy)ethane, brominated polyphenylene ether, brominated polystyrene and 2,4,6-tris(tribromophenoxy)-1,3,5-triazine.

While there are no particular restrictions on the amount of such flame retardant, it is preferred that the flame retardant be contained in an amount of 0.01 to 5 parts by mass, more preferably 0.05 to 4 parts by mass, even more preferably 0.1 to 3 parts by mass, per 100 parts by mass of the resin content in the resin film. When the amount of the flame retardant is within these ranges, a flame retardancy can be imparted to the resin film without changing the mechanical properties of the resin film.

### Maleimide Resin Film

There are no particular restrictions on a method for molding the resin film of the present invention. There may be employed, for example, a method where the maleimide resin composition of the resin film (i.e. the maleimide resin composition containing the components (a), (b), (c) and (d)) is to be spread onto a film or the like having a mold releasability, and then squeegeed.

At that time, it is preferred that the maleimide resin composition already have a lower viscosity after, for example, being heated or diluted with a solvent; more preferably, the maleimide resin composition already contains a later-described organic solvent (e). When diluted with the organic solvent, it is preferable if a thixotropic ratio of the composition diluted is 1.0 to 3.0, because a favorable workability can be achieved; it is more preferred that this thixotropic ratio be 1.0 to 2.5, even more preferably 1.0 to 2.0. Here, the thixotropic ratio is calculated based on the following formula in a way such that the viscosity of the composition at 25° C. is at first measured with a rotary viscometer described in JIS K 7117-1:1999 at different revolutions of the spindle.

Thixotropic ratio=(viscosity at 1 rpm[Pa·s]/viscosity at 10 rpm[Pa·s])

### (e) Organic Solvent

An organic solvent (e) is added to the maleimide resin composition to improve a workability thereof for molding the maleimide resin film.

There are no particular restrictions on such organic solvent, so long as the maleimide resin composition can be dissolved and uniformly dispersed therein. Specific examples of the organic solvent as the component (e) include toluene, xylene, methylethylketone, methylisobutylketone, cyclohexanone, cyclopentanone, anisole, diphenyl ether, propyl acetate and butyl acetate. Among these examples, preferred are xylene, cyclohexanone, cyclopentanone, anisole, butyl acetate and the like.

The amount of the component (e) is optimized in a way such that after diluting the maleimide resin composition containing the components (a) to (d) as resin film components, the thixotropic ratio of the composition diluted will fall into the range of 1.0 to 3.0. However, it is preferred that the component (e) be used in an amount of 2 to 40 parts by mass, more preferably 3 to 30 parts by mass, per 100 parts by mass of a total amount of the components (a) to (d).

Further, a resin film having a mold releasability to the maleimide resin film of the present invention may also be placed on the maleimide resin film. The resin film having such mold releasability is optimized based on the kind of an insulating resin. Specific examples of such resin film include fluorine-based resin films such as a PET (polyethylene terephthalate) film coated with a fluorine-based resin, a PET film coated with a silicone resin, a PTFE (polytetrafluoroethylene) film, an ETFE (poly(ethylene-tetrafluoroethylene)) film and a CTFE (polychlorotrifluoroethylene) film. This resin film improves a handling property of the maleimide resin film, and is capable of preventing foreign substances such as dust from adhering to the maleimide resin film.

It is preferred that the maleimide resin film of the present invention have a thickness of 1 to 2,000 μm, more preferably 1 to 500 μm, even more preferably 10 to 300 μm. When the thickness of the maleimide resin film is smaller than 1 μm, it will be difficult to attach it to a substrate or the like; when the thickness of the maleimide resin film is larger than 2,000 μm, the maleimide resin film will have a difficulty in maintaining a flexibility as a film. Further, it is preferred that the film thickness be twice the particle size of the inorganic particles as the component (c) or larger, more preferably three times the particle size of such inorganic particles or larger, even more preferably 5 to 1,000 times the particle size of such inorganic particles. It is preferable when the film thickness is within these ranges, because concavities and convexities caused by the inorganic particles are now less likely to occur on the film.

A method for using the maleimide resin film of the present invention may be as follows. That is, the resin film having the mold releasability is to be peeled off if such resin film is already placed on the maleimide resin film of the invention, followed by sandwiching the maleimide resin film between a substrate or the like and a semiconductor or the like, and then performing thermal compression bonding so as to cure the maleimide resin film. It is preferred that the maleimide resin film be heated at a temperature of 100 to 300° C. for 10 min to 4 hours, more preferably 120 to 250° C. for 20 min to 3 hours, even more preferably 150 to 200° C. for 30 min to 2 hours. It is preferred that a pressure for performing compression bonding be 0.01 to 100 MPa, more preferably 0.05 to 80 MPa, even more preferably 0.1 to 50 MPa.

### WORKING EXAMPLE

The present invention is described in greater detail hereunder with reference to synthetic, working and comparative examples. However, the present invention is not limited to the following working examples.

Maleimide (a-1)

Maleimide compound represented by the following formula (BMI-3000 by Designer Molecules Inc.) (molecular weight 4,000)

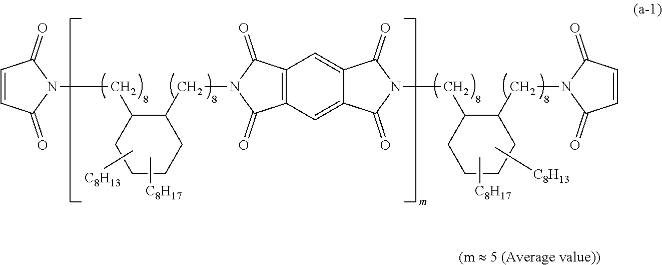

Maleimide (a-2)

Maleimide compound represented by the following formula (BMI-2500 by Designer Molecules Inc.) (molecular weight 3,500)

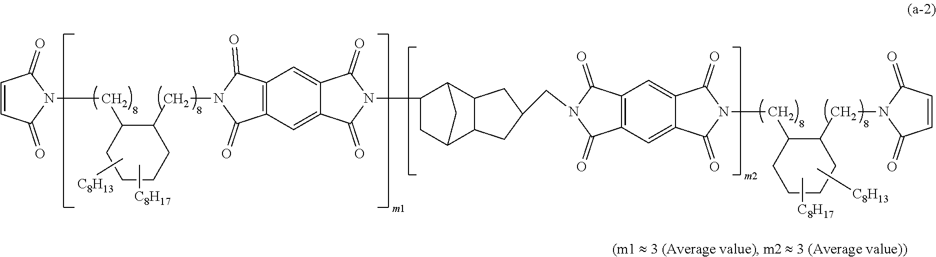

Maleimide (a-3)

Maleimide compound represented by the following formula (BMI-1500 by Designer Molecules Inc.) (molecular weight 2,100)

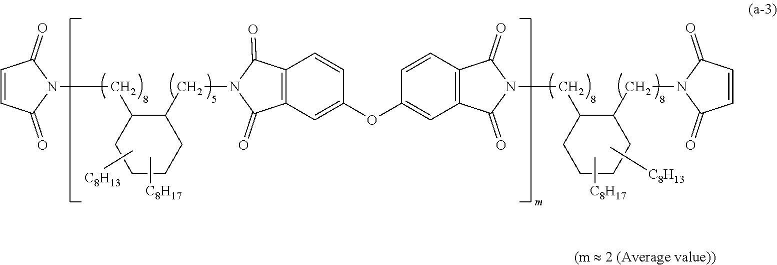

Maleimide (a-4)

KAYAHARD AA (by Nippon Kayaku Co., Ltd.) of 252 g (1.0 mol) and pyromellitic dianhydride of 207 g (0.9 mol) were added to N-methyl pyrrolidone of 350 g, followed by stirring them at room temperature for three hours, and then stirring them at 120° C. for another three hours. Maleic anhydride of 196 g (2.0 mol), sodium acetate of 82 g (1.0 mol) and acetic anhydride of 204 g (2.0 mol) were then added to the solution thus obtained, followed by performing stirring at 80° C. for an hour. Later, toluene of 500 g was added to the reaction solution, followed by washing the solution with water, dewatering the solution washed, and then distilling away the solvent under a reduced pressure to obtain a bismaleimide (a-4) represented by the following formula (molecular weight 1,800).

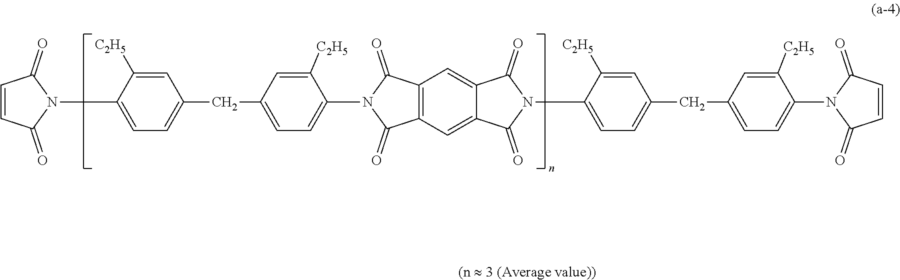

Maleimide (a-5)

Maleimide compound represented by the following formula (BM1-2300 by Daiwa Fine Chemicals Co., Ltd.) (molecular weight 400)

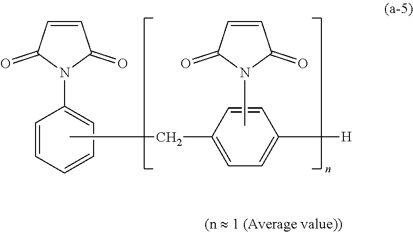

(a-6) Epoxy Resin “jER-828EL” (by Mitsubishi Chemical Corporation)
(a-7) Silicone Resin “LPS-3412” (by Shin-Etsu Chemical Co., Ltd.)

### (B-1) Acrylate Represented by the Following Formula (Kayarad R-684 by Nippon Kayaku Co., Ltd.)

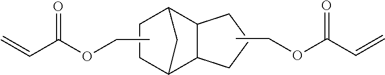

### (B-2) Cyclohexyl Methacrylate (Light Ester CH by Kyoeisha Chemical Co., Ltd.)

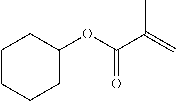

### (B-3) Isobornyl Acrylate (by Osaka Organic Chemical Industry Ltd.)

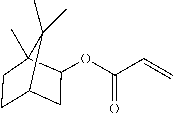

### (B-4) T-Butyl Acrylate (by Osaka Organic Chemical Industry Ltd.)

(c-1) Alumina (aluminum oxide) “*AC-9204” (by Admatechs Company Limited, average particle size 10 μm, density 3.9 g/cm³)
(c-2) Alumina (Aluminum Oxide) “AO-502” (by Admatechs Company Limited, Average Particle Size 0.7 μm, Density 3.9 g/Cm³)
(c-3) Boron Nitride “SGPS” (by Denka Company Limited, Average Particle Size 12 μm, Density 2.3 g/cm³)
(c-4) Silver “Ag-HWQ” (by Fukuda Metal Foil & Powder Co., Ltd., Average Particle Size 5 μm, Density 10 G/Cm³)

### (C-5) Yellow Phosphor YAG (by Mitsubishi Chemical Corporation, Average Particle Size 2 μM, Density 3.9 G/Cm³)

(c-6) Fe—Cr—Al Alloy (by Sanyo Special Steel Co., Ltd., Average Particle Size 4 μm, Density 7.9 g/Cm²)
(C-7) Ba₂Co₂Fe₁₂O₂₂ Ferrite (by Shin-Etsu Chemical Co., Ltd., Average Particle Size 6 μM, Density 4.1 G/Cm³)
(c-8) Titanium Oxide “CR-90” (by ISHIHARA SANGYO KAISHA, LTD., Average Particle Size 0.25 μm, Density 4.2 g/Cm³)
(c-9) Hollow Silica “SiliNax” (by Nittetsu Mining Co., Ltd., Average Particle Size 0.1 μm, Density 0.05 g/Cm³)
(d-1) Dicumylperoxide “PERCUMYL D” (by NOF CORPORATION)
(d-2) Triphenylphosphine (by Kishida Chemical Co., Ltd.)

### Working Example 1

Maleimide (a-1) of 80 g, (b-1) of 19 g, (d-1) of 1 g and xylene of 200 g were mixed and dissolved, followed by adding (c-3) of 1,000 g thereto, and then placing them in a stirrer THINKY CONDITIONING MIXER (by THINKY CORPORATION) so as to perform stirring and defoaming for 3 min, thereby obtaining a maleimide resin composition. An automatic coating device PI-1210 (TESTER SANGYO CO., LTD) was then used to apply the maleimide composition to an ETFE (ethylene-tetrafluoroethylene) film, followed by molding them into the shape of a film having a size of length 150 mm×width 150 mm×thickness 50 μm. Later, heating was performed at 100° C. for 30 min to volatilize xylene, thus obtaining a film being a solid at 25° C. and having a size of length 150 mm×width 150 mm×thickness 60 μm.

### Working Examples 2 to 9; Comparative Examples 1 to 18

In working examples 2 to 9; and comparative examples 1 to 16, maleimide resin compositions were prepared in a similar manner as the working example 1, based on the compounding ratios shown in Tables 1-1 and 1-2; films having the thicknesses shown in Tables 1-1 and 1-2 were then produced. In comparative example 17, (a-6) was used to prepare an epoxy resin composition. In comparative example 18, (a-7) was used to prepare a silicone resin composition. Here, a curing catalyst is already contained in (a-7). In comparative examples 16, 17 and 18, a poor compatibility was observed between resin and inorganic particles, and the compositions thus had a high thixotropy, which made film formation impossible. Therefore, in comparative examples 16, 17 and 18, the following evaluations for film were not conducted.

### Thixotropic Ratio Before Film Coating

In the working examples 1 to 9; and comparative examples 1 to 18, thixotropic ratios of the compositions were measured. Here, the thixotropic ratios were calculated based on the following formula in a way such that the viscosity of each composition at 25° C. was at first measured with a rotary viscometer described in JIS K 7117-1:1999 at different revolutions of the spindle. The results are shown in Tables 1-1 and 1-2.

Thixotropic ratio=(viscosity at 1 rpm[Pa·s]/viscosity at 10 rpm[Pa·s])

TABLE 1-1

| | | Working | Working | Working | Working | Working | Working | Working | Working |
|---|---|---|---|---|---|---|---|---|---|
| | | example 1 | example 2 | example 3 | example 4 | example 5 | example 6 | example 7 | example 8 |
| (a) | (a-1) | 80 | | | | 90 | 85 | 88 | |
| | (a-2) | | 85 | | | | | | 90 |
| | (a-3) | | | 90 | | | | | |
| | (a-4) | | | | 90 | | | | |
| | (a-5) | | | | | | | | |
| | (a-6) | | | | | | | | |
| | (a-7) | | | | | | | | |
| (b) | (b-1) | 19 | | 9 | | 9 | | 10 | |
| | (b-2) | | | | | | 14 | | |
| | (b-3) | | 14 | | 4 | | | | 9 |
| | (b-4) | | | | | | | | |
| (c) | (c-1) | | | 2500 | | | | | |
| | (c-2) | | | 300 | 1200 | | | | |
| | (c-3) | 1000 | | | | | | | |
| | (c-4) | | 4000 | | | | | | |
| | (c-5) | | | | | 1200 | | | |
| | (c-6) | | | | | | 2000 | | |
| | (c-7) | | | | | | | 2000 | |
| | (c-8) | | | | | | | | 2000 |
| | (c-9) | | | | | | | | |
| (d) | (d-1) | 1 | 1 | | | 1 | 1 | | 1 |
| | (d-2) | | | 1 | 1 | | | 2 | |
| | Xylene | 200 | 200 | 240 | 180 | 200 | 200 | 240 | 270 |

| | | | | | | | | |
|---|---|---|---|---|---|---|---|---|
| Volume percent of | 81 | 80 | 88 | 76 | 76 | 71 | 83 | 83 |
| inorganic particles | | | | | | | | |
| as component(c)(%) | | | | | | | | |
| Thixotropic ratio | 1.3 | 1.4 | 1.2 | 1.2 | 1.2 | 1.4 | 1.4 | 1.5 |
| before film coating | | | | | | | | |
| (1 rpm/10 rpm) | | | | | | | | |
| Film thickness(μm) | 80 | 500 | 1800 | 3 | 50 | 20 | 1000 | 5 |

| | | Working | Comparative | Comparative | Comparative | Comparative | Comparative |
|---|---|---|---|---|---|---|---|
| | | example 9 | example 1 | example 2 | example 3 | example 4 | example 5 |
| (a) | (a-1) | 88 | 90 | 90 | 100 | 85 | |
| | (a-2) | | | | | | 85 |
| | (a-3) | | | | | | |
| | (a-4) | | | | | | |
| | (a-5) | | | | | | |
| | (a-6) | | | | | | |
| | (a-7) | | | | | | |
| (b) | (b-1) | 10 | 9 | 9 | | | |
| | (b-2) | | | | | | |
| | (b-3) | | | | | | |
| | (b-4) | | | | | 14 | 14 |
| (c) | (c-1) | | 700 | 4000 | 2500 | | |
| | (c-2) | | 100 | 500 | 300 | | |
| | (c-3) | | | | | | |
| | (c-4) | | | | | 4000 | 4000 |
| | (c-5) | | | | | | |
| | (c-6) | | | | | | |
| | (c-7) | | | | | | |
| | (c-8) | | | | | | |
| | (c-9) | 30 | | | | | |
| (d) | (d-1) | | 1 | 1 | 1 | 1 | 1 |
| | (d-2) | 2 | | | | | |
| | Xylene | 260 | 160 | 300 | 250 | 230 | 200 |

| | | | | | | |
|---|---|---|---|---|---|---|
| Volume percent of | 86 | 67 | 92 | 88 | 80 | 80 |
| inorganic particles | | | | | | |
| as component(c)(%) | | | | | | |
| Thixotropic ratio | 1.5 | 1.1 | 1.5 | 1.2 | 1.3 | 1.3 |
| before film coating | | | | | | |
| (1 rpm/10 rpm) | | | | | | |
| Film thickness(μm) | 10 | 30 | 30 | 30 | 500 | 500 |

TABLE 1-2

| | | Comparative | Comparative | Comparative | Comparative | Comparative | Comparative | Comparative |
|---|---|---|---|---|---|---|---|---|
| | | example 6 | example 7 | example 8 | example 9 | example10 | example11 | example12 |
| (a) | (a-1) | 90 | 90 | 85 | 85 | 88 | 88 | |
| | (a-2) | | | | | | | 90 |
| | (a-3) | | | | | | | |
| | (a-4) | | | | | | | |
| | (a-5) | | | | | | | |
| | (a-6) | | | | | | | |
| | (a-7) | | | | | | | |
| (b) | (b-1) | 9 | 9 | | | 10 | 10 | |
| | (b-2) | | | 14 | 14 | | | |
| | (b-3) | | | | | | | 9 |
| | (b-4) | | | | | | | |
| (c) | (c-1) | | | | | | | |
| | (c-2) | | | | | | | |
| | (c-3) | | | | | | | |
| | (c-4) | | | | | | | |
| | (c-5) | 800 | 4500 | | | | | |
| | (c-6) | | | 1500 | 8000 | | | |
| | (c-7) | | | | | 700 | 4500 | |
| | (c-8) | | | | | | | 700 |
| | (c-9) | | | | | | | |
| (d) | (d-1) | 1 | 1 | | 1 | | | I |
| | (d-2) | | | | | 2 | 2 | |
| | Xylene | 170 | 500 | 150 | 400 | 150 | 350 | 180 |

| | | | | | | | |
|---|---|---|---|---|---|---|---|
| Volume percent of | 67 | 92 | 66 | 91 | 63 | 92 | 63 |
| inorganic particles | | | | | | | |
| as component(c)(%) | | | | | | | |
| Thixotropic ratio | 1.1 | 1.6 | 1.1 | 1.5 | 1.1 | 1.5 | 1.1 |
| before film coating | | | | | | | |
| (1 rpm/10 rpm) | | | | | | | |
| Film thickness(μm) | 50 | 50 | 20 | 20 | 1000 | 1000 | 5 |

| | | Comparative | Comparative | Comparative | Comparative | Comparative | Comparative |
|---|---|---|---|---|---|---|---|
| | | example13 | example14 | example15 | example16 | example17 | example18 |
| (a) | (a-1) | | 88 | 88 | | | |
| | (a-2) | 90 | | | | | |
| | (a-3) | | | | | | |
| | (a-4) | | | | | | |
| | (a-5) | | | | 90 | | |
| | (a-6) | | | | | 100 | |
| | (a-7) | | | | | | 100 |
| (b) | (b-1) | | 10 | 10 | 9 | | |
| | (b-2) | | | | | | |
| | (b-3) | 9 | | | | | |
| | (b-4) | | | | | | |
| (c) | (c-1) | | | | 2500 | | |
| | (c-2) | | | | 300 | | |
| | (c-3) | | | | | 1000 | 1000 |
| | (c-4) | | | | | | |
| | (c-5) | | | | | | |
| | (c-6) | | | | | | |
| | (c-7) | | | | | | |
| | (c-8) | 5000 | | | | | |
| | (c-9) | | 10 | 50 | | | |
| (d) | (d-1) | 1 | | | 1 | 1 | |
| | (d-2) | | 2 | 2 | | | |
| | Xylene | 400 | 180 | 500 | 400 | 300 | 400 |

| | | | | | | |
|---|---|---|---|---|---|---|
| Volume percent of | 92 | 67 | 91 | 88 | 81 | 81 |
| inorganic particles | | | | | | |
| as component(c)(%) | | | | | | |
| Thixotropic ratio | 1.6 | 1.3 | 1.9 | 3.5 | 3.1 | 3.4 |
| before film coating | | | | | | |
| (1 rpm/10 rpm) | | | | | | |
| Film thickness(μm) | 5 | 10 | 10 | Unmeasurable | Unmeasurable | Unmeasurable |

### Measurement of Relative Permittivity and Dielectric Tangent

A mold frame having a size of 60 mm×60 mm and a thickness of 0.1 mm was used to sandwich an uncured film obtained in each of the working examples 1 to 9; and comparative examples 1 to 15, followed by performing hot press at 180° C. for an hour, thereby obtaining a test sample. The cured product prepared was then connected to a network analyzer (E5063-2D5 by Keysight Technologies) and a stripline (by KEYCOM Corp.) to measure a relative permittivity and a dielectric tangent. The results thereof are shown in Tables 2 to 7.

### Adhesion Force Measurement

The film produced in each of the working examples 1 to 9; and comparative examples 1 to 15 was attached to a 20 mm-squared silicon wafer, followed by pressing a 2 mm-squared silicon chip thereagainst from above, and then heating them at 180° C. for an hour so as to complete curing. Later, an adhesion force measurement device (universal bond tester, series 4000 (DS-100) by Nordson Corporation) was used to measure an adhesion force observed when flicking the chip sideways (die shear test). The results thereof are shown in Tables 2 to 7.

### Density Measurement

The uncured film obtained in each of the working examples 1 to 9; and comparative examples 1 to 15 was folded and pressed, and then heated at 180° C. for an hour so as to be cured, thereby obtaining a disk-shaped cured product having a diameter of 50 mm and a thickness of 3 mm. This cured product was handled as a test piece, and AD-1653 (by A&D Company, Limited) was then used to measure a density thereof at 23° C. in accordance with JIS K 7112:1999. The results thereof are shown in Tables 2 to 7.

### Thermal Conductivity Measurement

In the working examples 1 to 4 and comparative examples 1 to 5 where (c-1) to (c-4) were used as the component (C), the uncured film obtained was folded and pressed, and then heated at 180° C. for an hour so as to be cured, followed by punching it to obtain a disk-shaped cured product having a diameter of 1 cm and a thickness of 2 mm, and then coating the whole cured product with carbon black. The cured product coated was handled as a test piece, and a laser flash method (LFA 447 Nanoflash by NETZSCH-Geratebau GmbH) was then used to measure a thermal conductivity thereof in accordance with JIS R 1611:2010. The results thereof are shown in Table 2.

TABLE 2

| | | | Working | Working | Working | Working | Comparative |
|---|---|---|---|---|---|---|---|
| | | | example 1 | example 2 | example 3 | example 4 | example 1 |
| Evaluation | Relative | | 3.7 | 1500 | 6.8 | 5.4 | 5.5 |
| result | permittivity | | | | | | |
| | (10 GHz) | | | | | | |
| | Dielectric | | 0.0018 | 0.15 | 0.0025 | 0.0023 | 0.0021 |
| | tangent | | | | | | |
| | (10 GHz) | | | | | | |
| | Adhesion force | MPa | 21 | 21 | 15 | 23 | 25 |
| | Density | g/cm³ | 2 | 9.4 | 3.6 | 3.3 | 3.2 |
| | Thermal | W/m · K | 12 | 70 | 11 | 7 | 3 |
| | conductivity | | | | | | |
| | (Thickness | | | | | | |
| | direction) | | | | | | |

| | | | Comparative | Comparative | Comparative | Comparative |
|---|---|---|---|---|---|---|
| | | | example 2 | example 3 | example 4 | example 5 |
| Evaluation | Relative | | 7.2 | 6.6 | 1500 | 1500 |
| result | permittivity | | | | | |
| | (10 GHz) | | | | | |
| | Dielectric | | 0.0032 | 0.0025 | 0.15 | 0.15 |
| | tangent | | | | | |
| | (10 GHz) | | | | | |
| | Adhesion force | MPa | 5 | 9 | 8 | 8 |
| | Density | g/cm³ | 3.8 | 3.6 | 9.4 | 9.4 |
| | Thermal | W/m · K | 11 | 11 | 70 | 70 |
| | conductivity | | | | | |
| | (Thickness | | | | | |
| | direction) | | | | | |

### Luminance Measurement

The uncured film obtained in each of the working example 5 and comparative examples 6 and 7 where (c-5) was used as the component (c), was sandwiched between two ETFE films, followed by using a hot press machine to perform compression molding at a temperature of 80° C. and under a pressure of 5 t for 5 min, thereby obtaining a composition sheet molded into the shape of a sheet having a thickness of 50 μm. The composition sheet obtained was then cut into smaller pieces of a chip size together with the ETFE films. The ETFE film on one side of each sheet piece thus obtained was peeled off, and the sheet piece was then placed on a GaN-based flip-chip type LED chip in a way such that the side of the sheet piece with the composition being exposed would come into contact with the LED chip. The ETFE film on the other side was then removed after placing the sheet piece on the LED chip in such a way. Next, hot molding was performed at 180° C. for 30 min to form on the LED chip a cured phosphor-containing resin layer. The flip-chip type LED device thus obtained was then electrified with a current of 100 mA so as to turn on the LED, followed by using an LED optical property monitor (LE-3400 by Otsuka Electronics Co.. Ltd.) to measure the luminance of the LED. This measurement was performed on three LED devices, and an average value thereof was obtained. The results are shown in Table 3.

TABLE 3

| | | | Working | Comparative | Comparative |
|---|---|---|---|---|---|
| | | | example | example | example |
| | | | 5 | 6 | 7 |
| Eval- | Relative | | 6.3 | 5.8 | 8.3 |
| uation | permittivity | | | | |
| result | (10 GHz) | | | | |
| | Dielectric | | 0.003 | 0.003 | 0.004 |
| | tangent | | | | |
| | (10 GHz) | | | | |
| | Adhesion | MPa | 23 | 30 | 4 |
| | force | | | | |
| | Density | g/cm³ | 3.3 | 3.1 | 3.7 |
| | Luminance | lm · W | 150 | 80 | 160 |

### Coercive Force Measurement

In the working example 6 and comparative examples 8 and 9 where (c-6) was used as the component (C), the uncured film obtained was folded and pressed, and then heated at 180° C. for an hour so as to be cured, thereby obtaining a composition sheet of a size of length 3 cm×width 4 cm×thickness 1 mm. A vibrating sample magnetometer (VSM-C7 by Toei Industry Co., Ltd.) was then used to measure the coercive force of the composition sheet obtained. The results thereof are shown in Table 4.

TABLE 4

| | | | Working | Comparative | Comparative |
|---|---|---|---|---|---|
| | | | example | example | example |
| | | | 6 | 8 | 9 |
| Evaluation | Relative | | 1200 | 900 | 1600 |
| result | permittivity | | | | |
| | (10 GHz) | | | | |
| | Dielectric | | 0.12 | 0.1 | 0.15 |
| | tangent | | | | |
| | (10 GHz) | | | | |
| | Adhesion | MPa | 25 | 35 | 4 |
| | force | | | | |
| | Density | g/cm³ | 6.7 | 6.1 | 7.5 |
| | Coercive | kA/m | 200 | 100 | 250 |
| | force | | | | |

### Evaluation of Electromagnetic Wave Absorbing Property

In the working example 7 and comparative examples 10 and 11 where (c-7) was used as the component (C), the uncured film obtained was folded and pressed, and then heated at 180° C. for an hour so as to be cured, thereby obtaining a composition sheet of a size of length 3 cm×width 4 cm×thickness 100 μm. As a transmitter and a detector, a network analyzer (8722D by Agilent Technologies, Inc.) was used; and an antenna (CC28S by KEYCOM Corp.) as well as a lens (LAS-140B by KEYCOM Corp.) were also used. An absorption rate at a wavelength of 37 GHz was then calculated using these equipments. The results thereof are shown in Table 5.

TABLE 5

| | | | Working | Comparative | Comparative |
|---|---|---|---|---|---|
| | | | example | example | example |
| | | | 7 | 10 | 11 |
| Evaluation | Relative | | 230 | 180 | 280 |
| result | permittivity | | | | |
| | (10 GHz) | | | | |
| | Dielectric | | 0.004 | 0.003 | 0.005 |
| | tangent | | | | |
| | (10 GHz) | | | | |
| | Adhesion | MPa | 20 | 25 | 2 |
| | force | | | | |
| | Density | g/cm³ | 3.7 | 3.2 | 3.9 |
| | Absorption | dB | −40 | −20 | −50 |
| | rate | | | | |

### Optical Reflectivity

In the working example 8 and comparative examples 12 and 13 where (c-8) was used as the component (C), the uncured film obtained was folded and pressed, and then heated at 180° C. for an hour so as to be cured, thereby obtaining a disk-shaped cured product having a diameter of 50 mm and a thickness of 3 mm. X-rite 8200 (by S.D.G K.K.) was then used to measure an optical reflectivity at 450 nm. The results thereof are shown in Table 6.

TABLE 6

| | | | Working | Comparative | Comparative |
|---|---|---|---|---|---|
| | | | example | example | example |
| | | | 8 | 12 | 13 |
| Eval- | Relative | | 120 | 90 | 150 |
| uation | permittivity | | | | |
| result | (10 GHz) | | | | |
| | Dielectric | | 0.008 | 0.005 | 0.011 |
| | tangent | | | | |
| | (10 GHz) | | | | |
| | Adhesion | MPa | 20 | 45 | 10 |
| | force | | | | |
| | Density | g/cm³ | 3.7 | 3.1 | 4 |
| | Optical | % | 95 | 80 | 97 |
| | reflectivity | | | | |

Films obtained in the working example 9 and comparative examples 14 and 15 that contained the hollow silica (c-9) as the component (c) were also evaluated, and the results thereof are shown in Table 7.

TABLE 7

| | | | Working | Comparative | Comparative |
|---|---|---|---|---|---|
| | | | example | example | example |
| | | | 9 | 14 | 15 |
| Eval- | Relative | | 2.1 | 2.6 | 1.8 |
| uation | permittivity | | | | |
| result | (10 GHz) | | | | |
| | Dielectric | | 0.0008 | 0.002 | 0.0006 |
| | tangent | | | | |
| | (10 GHz) | | | | |
| | Adhesion | MPa | 20 | 25 | 1 |
| | force | | | | |
| | Density | g/cm³ | 0.4 | 0.6 | 0.2 |

In the working examples 1 to 4, a maleimide resin film having a high thermal conductivity and a sufficient adhesion force was able to be produced. In the working examples 5 to 9, a maleimide resin film capable of being highly filled with the inorganic particles and having a sufficient adhesion force was able to be produced.

In the comparative example 1, a low value of thermal conductivity was exhibited due to an insufficient amount of the inorganic particles. In the comparative example 2, a low value of the adhesion force was exhibited as the film produced was brittle due to an excessively large amount of the inorganic particles. In the comparative example 3, a low value of the adhesion force was exhibited as the composition did not contain, as the component (b), the (meth)acrylate having not less than 10 carbon atoms. In the comparative examples 4 and 5, low values of the adhesion force were exhibited as the (meth)acrylate as the component (b) only had 7 carbon atoms. In the comparative example 6, a low value of luminance was exhibited due to an insufficient amount of the phosphor particles. In the comparative example 7, a low value of the adhesion force was exhibited as the film produced was brittle due to an excessively large amount of the phosphor particles. In the comparative example 8, a low value of the coercive force was exhibited due to an insufficient amount of the magnetic particles. In the comparative example 9, a low value of the adhesion force was exhibited as the film produced was brittle due to an excessively large amount of the magnetic particles. In the comparative example 10, a low value of the absorption rate was exhibited due to an insufficient amount of the electromagnetic wave-absorbing particles. In the comparative example 11, a low value of the adhesion force was exhibited as the film produced was brittle due to an excessively large amount of the electromagnetic wave-absorbing particles. In the comparative example 12, a low value of the reflectivity was exhibited due to an insufficient amount of the white particles. In the comparative example 13, a low value of the adhesion force was exhibited as the film produced was brittle due to an excessively large amount of the white particles. In the comparative example 14, high values of relative permittivity and dielectric tangent were exhibited due to an insufficient amount of the hollow particles. In the comparative example 15, a low value of the adhesion force was exhibited as the film produced was brittle due to an excessively large amount of the hollow particles. In the comparative examples 16, 17 and 18, a poor compatibility between resin and inorganic particles led to a high thixotropy, which made it impossible to perform coating so that the composition would be turned into the shape of a film.

In this way, it became clear that the maleimide resin film of the present invention was capable of being highly filled with the inorganic particles due to a particular composition thereof, and exhibiting various functions depending on the properties of the inorganic particles, and had a superior adhesion force.

Here, the present invention is not limited to the above embodiments. The above embodiments are merely examples; and any embodiment shall be included in the technical scope of the present invention so long as the embodiment has a composition substantively identical to the technical idea(s) described in the scope of claims of the present invention, and has functions and effects that are similar to those of the present invention.

What is claimed is:

1. A method for producing a maleimide resin film comprising the steps of:
applying a maleimide composition which is a fluid to form the shape of a film, the maleimide composition comprising:
(a) a maleimide represented by the following formula (1): 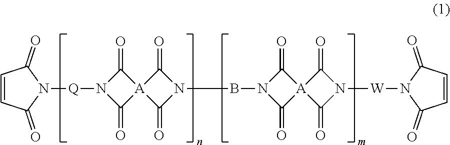
wherein A independently represents a tetravalent organic group having a cyclic structure(s); B independently represents an alkylene group that has not less than 6 carbon atoms and at least one aliphatic ring having not less than 5 carbon atoms, and may contain a hetero atom; Q independently represents an arylene group that has not less than 6 carbon atoms, and may contain a hetero atom; W represents a group represented by B or Q; n represents a number of 0 to 100, m represents a number of 0 to 100, provided that at least one of n or m is a positive number;
(b) a (meth)acrylate having not less than 10 carbon atoms;
(c) inorganic particles in an amount of 70 to 90% by volume with respect to the whole resin film;
(d) a curing catalyst; and
(e) an organic solvent, and
volatilizing the organic solvent (e) from the maleimide composition so as to obtain the maleimide resin film which is a solid and uncured resin film.

2. The method for producing a maleimide resin film according to claim 1, wherein the organic group represented by A in the formula (1) is any one of the tetravalent organic groups represented by the following structural formulae 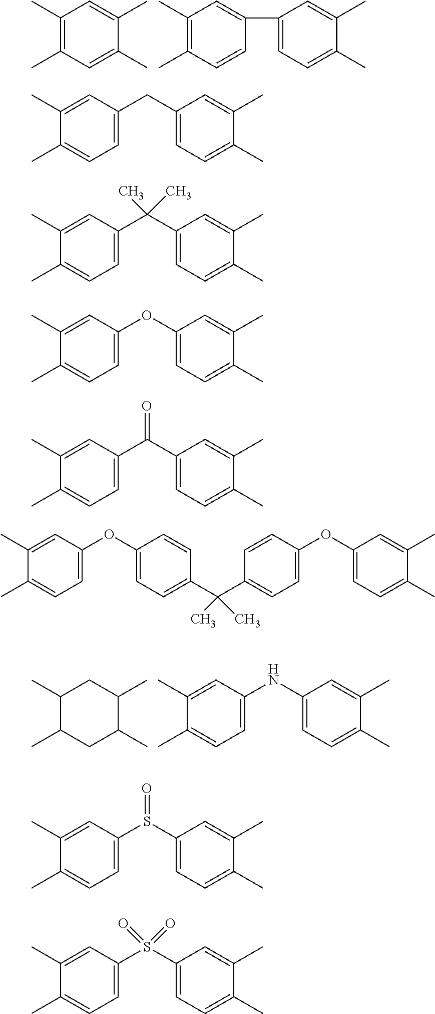
wherein bonds in the above structural formulae that are yet unbonded to substituent groups are to be bonded to carbonyl carbons forming cyclic imide structures in the formula (1).

3. The method for producing a maleimide resin film according to claim 1, wherein component (b), has at least one aliphatic ring having not less than 5 carbon atoms.

4. The method for producing a maleimide resin film according to claim 1, wherein the inorganic particles as the component (c) are at least one selected from the group consisting of electrically conductive particles, thermally conductive particles, a phosphor, magnetic particles, white particles, hollow particles and electromagnetic wave-absorbing particles.

5. The method for producing a maleimide resin film according to claim 1, wherein the inorganic particles as the component (c) are at least one kind of electrically conductive particles selected from the group consisting of elemental metal particles that are gold particles, silver particles, copper particles, palladium particles, aluminum particles, nickel particles, iron particles, titanium particles, manganese particles, zinc particles, tungsten particles, platinum particles, lead particles and tin particles; and alloy particles that are solder particles, steel particles and stainless steel particles.

6. The method for producing a maleimide resin film according to claim 1, wherein the inorganic particles as the component (c) are at least one kind of thermally conductive particles selected from the group consisting of boron nitride particles, aluminum nitride particles, silicon nitride particles, beryllium oxide particles, magnesium oxide particles, zinc oxide particles, aluminum oxide particles, silicon carbide particles, diamond particles and graphene particles.

7. The method for producing a maleimide resin film according to claim 1, wherein the inorganic particles as the component (c) are at least one kind of magnetic particles selected from the group consisting of iron particles, cobalt particles, nickel particles, stainless steel particles, Fe—Cr—Al—Si alloy particles, Fe—Si—Al alloy particles, Fe—Ni alloy particles, Fe—Cu—Si alloy particles, Fe—Si alloy particles, Fe—Si—B(—Cu—Nb) alloy particles, Fe—Si—Cr—Ni alloy particles, Fe—Si—Cr alloy particles, Fe—Si—Al—Ni—Cr alloy particles, Fe₂O₃ particles, Fe₃O₄ particles, Mn—Zn-based ferrite particles, Ni—Zn-based ferrite particles, Mg—Mn-based ferrite particles, Zr—Mn-based ferrite particles, Ti—Mn-based ferrite particles, Mn—Zn—Cu-based ferrite particles, barium ferrite particles and strontium ferrite particles.

8. The method for producing a maleimide resin film according to claim 1, wherein the inorganic particles as the component (c) are at least one kind of white particles selected from the group consisting of titanium dioxide particles, yttrium oxide particles, zinc sulfate particles, zinc oxide particles and magnesium oxide particles.

9. The method for producing a maleimide resin film according to claim 1, wherein the inorganic particles as the component (c) are at least one kind of hollow particles selected from the group consisting of silica balloons, carbon balloons, alumina balloons, aluminosilicate balloons and zirconia balloons.

10. The method for producing a maleimide resin film according to claim 1, wherein the inorganic particles as the component (c) are at least one kind of electromagnetic wave-absorbing particles selected from the group consisting of carbon black particles, acetylene black particles, ketjen black particles, carbon nanotube particles, graphene particles, fullerene particles, carbonyl iron particles, electrolytic iron particles, Fe—Cr-based alloy particles, Fe—Al-based alloy particles, Fe—Co-based alloy particles, Fe—Cr—Al-based alloy particles, Fe—Si—Ni-based alloy particles, Mg—Zn-based ferrite particles, Ba₂Co₂Fe₁₂O₂₂ particles, Ba₂Ni₂Fe₁₂O₂₂ particles, Ba₂Zn₂Fe₁₂O₂₂ particles, Ba₂Mn₂Fe₁₂O₂₂ particles, Ba₂Mg₂Fe₁₂O₂₂ particles, Ba₂Cu₂Fe₁₂O₂₂ particles, Ba₃Co₂Fe₂₄O₄₁ particles, BaFe₁₂O₁₉ particles, SrFe₁₂O₁₉ particles, BaFe₁₂O₂₂ particles and SrFe₁₂O₁₉ particles.

11. The method for producing a maleimide resin film according to claim 1, wherein the maleimide resin composition has a thixotropic ratio of 1.0 to 3.0 at 25° C.

12. The method for producing a maleimide resin film according to claim 1, wherein the resin component in the maleimide composition consists of the component (a), (b) and (d).

13. The method for producing a maleimide resin film according to claim 1, wherein the component (e) is at least one selected from the group consisting of toluene, xylene, methylethylketone, methylisobutylketone, cyclohexanone, cyclopentanone, anisole, diphenyl ether, propyl acetate and butyl acetate.
